(19) United States
(12) Patent Application Publication
(10) Pub. No.: US 2009/0028280 A1
(43) Pub. Date: Jan. 29, 2009

(54) TRANSMITTER AND TRANSMITTER/RECEIVER

(75) Inventors: Ryogo Yanagisawa, Osaka (JP); Satoshi Takahashi, Osaka (JP); Yoshihiro Tabira, Osaka (JP)

Correspondence Address: MCDERMOTT WILL & EMERY LLP, 600 13TH STREET, NW, WASHINGTON, DC, 20005-3096, US

(73) Assignee: Matsushita Electric Industrial Co., Ltd

(21) Appl. No.: 12/280,726

(22) PCT Filed: Jan. 9, 2007
(86) PCT No.: PCT/JP2007/050092

§ 371 Date: Aug. 26, 2008

(30) Foreign Application Priority Data
Mar. 1, 2006 (JP) 2006-055125

(51) Int. Cl. H04L 7/00

(52) U.S. Cl. 375/371

(57) ABSTRACT

A clock control circuit 22 in a control circuit 21 provided in a transmitter 25 controls a gate circuit 12 based on an instruction from a microcomputer 32 to stop the output of the clock to a cable 115 for a first predetermined period of time. Then, a read-out circuit in the microcomputer 32 accesses an EDID 31 stored in an information storing circuit of a receiver 43 via the cable 115, and specifies the first predetermined period of time based on the EDID 31. A reconfiguration circuit 42 provided in the receiver 43 counts the clock-holding state, and resets at least one of the receiver 43 and a TV 114 if the clock has been stopped for a second predetermined period of time. This reset operation suppresses the display of noise on the TV 114. Therefore, the occurrence of noise due to mis-latching between the clock and the data can be reduced even after a signal switching that entails a change in the clock frequency.

### TECHNICAL FIELD

The present invention relates to a transmitter and a transmitter/receiver for digital signals, and more particularly to a transmitter and a transmitter/receiver used for transmitting data such as video signals and audio signals of a STB (Set Top Box), a DVD player, a DVD recorder, or the like.

### BACKGROUND ART

Transmitters and transmitters/receivers for digital signals widely employ the DVI (Digital Visual Interface) standard as described in Patent Document 1, for example. The HDMI (High Definition Multimedia Interface) standard capable of transmitting a video signal multiplexed with an audio signal is known in the art, as an extension of the DVI standard. The HDMI standard is upper compatible with the DVI standard, and basically uses the same transmission method and transmission/reception method as those of the DVI standard. Therefore, conventional transmitters and conventional transmitters/receivers will be herein described with respect to the DVI standard.

FIG. 19 shows a conventional technique for a transmitter and a transmitter/receiver used for transmitting a video signal.

In the figure, 14 denotes an encoder, 15 a parallel-serial converter, 16 a 10-times multiplication PLL (Phase Locked Loop), 17 a frequency divider, 18 an MPEG2 decoder, 191 a microcomputer, 110 a serial-parallel converter, 111 a decoder, 112 a clock recovery circuit, 113 a frequency divider, 114 a TV, and 115 a cable. Moreover, 190 denotes a transmitter and 117 a receiver, wherein the transmitter 190 and the receiver 117 together form a transmitter/receiver.

While data are transmitted through three channels of R, G and B in the DVI standard, FIG. 19 shows only one channel for the sake of simplicity. Referring to FIG. 19, the operation of the conventional transmitter and transmitter/receiver will now be described.

The MPEG2 decoder 18 decodes the MPEG2 data recorded on a DVD disc, or the like, based on an instruction from the microcomputer 19, to thereby output a clock CLK and an 8-bit video signal in synchronism with the clock CLK as data. When the 8-bit data is input to the transmitter 190, the encoder 14 subjects the 8-bit data to an 8-bit-10-bit conversion to output 10-bit data. In the 8-bit-10-bit conversion, two bits are added so that “1”s or “0”s will not appear consecutively over a long period while achieving the DC balance when the data is converted from parallel to serial. After the 8-bit-10-bit conversion, the 10-bit parallel data is converted by the parallel-serial converter 15 to 1-bit serial data and sent to the cable 115 being a transmission line.

When the clock CLK is input to the transmitter 16, the 10-times multiplication PLL 16 produces a clock (CLK×10) whose frequency is 10 times that of the input clock CLK by means of the PLL effect. Using the clock of the ×10 frequency, the parallel-serial converter 15 converts the 10-bit parallel data to 1-bit serial data. The clock converted to the ×10 frequency is converted by the frequency divider 17 to a 1/10 frequency and sent to the cable 115.

Through the above operation, a clock of the same frequency as the clock CLK, which is input to the transmitter 190, and serial data in synchronism with the clock (CLK×10) whose frequency is 10 times that of the clock CLK are sent to the cable 115.

A jitter is present between the clock and the serial data input to the receiver 117 via the cable 115. This is a jitter obtained by adding a jitter occurring along the cable 115 to a jitter occurring in the transmitter 190. The clock recovery circuit 112 in the receiver 117 multiplies the received clock by 10 to produce the clock of the ×10 frequency, following the jitter of the received serial data. Then, the serial-parallel converter 110 uses the clock of the ×10 frequency to convert the 1-bit serial data to 10-bit parallel data. The decoder 111 subjects the 10-bit parallel data to a 10-bit-8-bit conversion to thereby restore the 8-bit data.

The clock, which has been multiplied by 10 in the clock recovery circuit 112, is frequency-divided by the frequency divider 113 to 1/10 to thereby restore the clock transmitted from the transmitter 190.

As described above, from the clock and the serial data received via the cable 115, the receiver 117 outputs the 8-bit parallel data and the clock in synchronism with the data, which have been input from the MPEG2 decoder 18 to the transmitter 190. The clock and data are input to the TV 114 to display the image.

Patent Document 1: Japanese Laid-Open Patent Publication No. 2002-314970

### DISCLOSURE OF THE INVENTION

### Problems to be Solved by the Invention

The DVI standard defines the transmission of video signals of various video formats. For example, a standard signal having a clock frequency of 27 MHz (hereinafter referred to as an “SD signal”) and a high-vision signal having a clock frequency of 74.175 MHz (hereinafter referred to as an “HD signal”) can be transmitted. It is also possible to switch from the SD signal to the HD signal in the middle of transmission.

However, when the video format is switched from the SD signal to the HD signal, the clock frequency is switched from 27 MHz to 74.175 MHz. Therefore, the clock recovery circuit 112 in the receiver 117 needs to again follow the change in the clock frequency and follow the jitter between the clock and the serial data. Specifically, unlocking between the clock and the data occurs, thus requiring re-synchronization of the clock. During the re-synchronization of the clock, synchronism between the data and the clock of the ×10 frequency cannot be achieved in the serial-parallel converter 110, thus causing mis-latching and producing garbled data. Therefore, at a signal-switching point, garbled data is displayed on the TV 114 as noise until the synchronism between the data and the clock is restored. Since the time constant of the response of the clock recovery circuit 112 varies depending on the receiver 117, the amount of time for which noise is displayed on the TV 114 varies depending on the receiver 117. Also when the signal is switched from the HD signal to the SD signal, garbled data similarly occurs, and noise is displayed on the TV 114.

Such noise as described above may also occur not only with the DVI standard but also when transmitting/receiving data in the HDMI standard or in other schemes similar to the DVI standard.

The present invention has been made in view of the problems as set forth above, and has an object to provide a transmitter and a transmitter/receiver, in which the occurrence of noise due to mis-latching between the clock and the data can be reduced even after a signal switching that entails a change in the clock frequency.

### Means for Solving the Problems

In order to achieve the object as set forth above, the present invention provides a transmitter and a transmitter/receiver employing a configuration where the transmission of the clock and the data from the transmitter means is stopped for a predetermined period of time.

Specifically, the present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the clock from the transmitter means for a predetermined amount of time when switching the frequency of the clock from one to another.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the clock from the transmitter means for a predetermined amount of time when switching the frequency of the clock from one to another, wherein the control means is given in advance information on the receiver, and specifies the predetermined amount of time for which the transmission of the clock is stopped based on the receiver information.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data to a receiver via a transmission line, the data being in synchronism with another clock whose frequency is N times that of the clock (where N is a natural number); control means for stopping the transmission of the clock from the transmitter means for a predetermined amount of time when switching the frequency of the clock from one to another; and read-out means for reading out information on the receiver from the receiver via the transmission line, wherein the control means specifies the predetermined amount of time for which the transmission of the clock is stopped based on the receiver information read out by the read-out means.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the clock from the transmitter means for a first predetermined amount of time when switching the frequency of the clock from one to another; and the receiver includes: receiver means connected to the transmitter means via a transmission line; and reconfiguration means for reconfiguring the receiver means upon detecting that the clock received by the receiver means has stopped for a second predetermined amount of time.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the clock from the transmitter means for a first predetermined amount of time when switching the frequency of the clock from one to another; the receiver includes: receiver means connected to the transmitter means via a transmission line; and reconfiguration means for reconfiguring the receiver means upon detecting that the clock received by the receiver means has stopped for a second predetermined amount of time; and the control means provided in the transmitter is given in advance information on the receiver means provided in the receiver, and specifies the first predetermined amount of time for which the transmission of the clock is stopped based on the receiver means information.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); control means for stopping the transmission of the clock from the transmitter means for a first predetermined amount of time when switching the frequency of the clock from one to another; and read-out means for reading out information on the receiver; the receiver includes: receiver means connected to the transmitter means via a transmission line; reconfiguration means for reconfiguring the receiver means upon detecting that the clock received by the receiver means has stopped for a second predetermined amount of time; and information storing means for storing information on the receiver means or the reconfiguration means; the read-out means provided in the transmitter reads out the information stored in the information storing means; and the control means provided in the transmitter specifies the first predetermined amount of time for which the transmission of the clock is stopped based on the information stored in the information storing means and read out by the read-out means.

The present invention is directed to a transmitter/receiver as set forth above, wherein the information stored in the information storing means provided in the receiver at least includes information on a manufacturer of the receiver means or the reconfiguration means.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the data from the transmitter means for a predetermined amount of time when switching the frequency of the clock from one to another.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the data from the transmitter means for a predetermined amount of time when switching the frequency of the clock from one to another, wherein the control means is given in advance information on the receiver, and specifies the predetermined amount of time for which the transmission of the data is stopped based on the receiver information.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data to a receiver via a transmission line, the data being in synchronism with another clock whose frequency is N times that of the clock (where N is a natural number); control means for stopping the transmission of the data from the transmitter means for a predetermined amount of time when switching the frequency of the clock from one to another; and read-out means for reading out information on the receiver from the receiver via the transmission line, wherein the control means specifies the predetermined amount of time for which the transmission of the data is stopped based on the receiver information read out by the read-out means.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the data from the transmitter means for a first predetermined amount of time when switching the frequency of the clock from one to another; and the receiver includes: receiver means connected to the transmitter means via a transmission line; and reconfiguration means for reconfiguring the receiver means upon detecting that the data received by the receiver means has stopped for a second predetermined amount of time.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the data from the transmitter means for a first predetermined amount of time when switching the frequency of the clock from one to another; the receiver includes: receiver means connected to the transmitter means via a transmission line; and reconfiguration means for reconfiguring the receiver means upon detecting that the data received by the receiver means has stopped for a second predetermined amount of time; and the control means provided in the transmitter is given in advance information on the receiver means provided in the receiver, and specifies the first predetermined amount of time for which the transmission of the data is stopped based on the receiver means information.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); control means for stopping the transmission of the data from the transmitter means for a first predetermined amount of time when switching the frequency of the clock from one to another; and read-out means for reading out information on the receiver; the receiver includes: receiver means connected to the transmitter means via a transmission line; reconfiguration means for reconfiguring the receiver means upon detecting that the data received by the receiver means has stopped for a second predetermined amount of time; and information storing means for storing information on the receiver means or the reconfiguration means; the read-out means provided in the transmitter reads out the information stored in the information storing means; and the control means provided in the transmitter specifies the first predetermined amount of time for which the transmission of the data is stopped based on the information stored in the information storing means and read out by the read-out means.

The present invention is directed to a transmitter/receiver as set forth above, wherein the information stored in the information storing means provided in the receiver at least includes information on a manufacturer of the receiver means or the reconfiguration means.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the clock and the data from the transmitter means for a predetermined amount of time when switching the frequency of the clock from one to another.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data, the data being in synchronism with another clock whose frequency is N times that of the clock (where N is a natural number); and control means for stopping the transmission of the clock and the data from the transmitter means for a predetermined amount of time when switching the frequency of the clock from one to another, wherein the control means is given in advance information on the receiver, and specifies the predetermined amount of time for which the transmission of the clock and the data is stopped based on the receiver information.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter for transmitting a clock and data to a receiver, including: transmitter means for transmitting a clock and data to a receiver via a transmission line, the data being in synchronism with another clock whose frequency is N times that of the clock (where N is a natural number); control means for stopping the transmission of the clock and the data from the transmitter means for a predetermined amount of time when switching the frequency of the clock from one to another; and read-out means for reading out information on the receiver from the receiver via the transmission line, wherein the control means specifies the predetermined amount of time for which the transmission of the clock and the data is stopped based on the receiver information read out by the read-out means.

The present invention is directed to a transmitter as set forth above, wherein the receiver information at least includes information on a manufacturer of the receiver.

The present invention is directed to a transmitter as set forth above, wherein the transmitter means transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the clock and the data from the transmitter means for a first predetermined amount of time when switching the frequency of the clock from one to another; and the receiver includes: receiver means connected to the transmitter means via a transmission line; and reconfiguration means for reconfiguring the receiver means upon detecting that the clock or the data received by the receiver means has stopped for a second predetermined amount of time.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); and control means for stopping the transmission of the clock and the data from the transmitter means for a first predetermined amount of time when switching the frequency of the clock from one to another; the receiver includes: receiver means connected to the transmitter means via a transmission line; and reconfiguration means for reconfiguring the receiver means upon detecting that the clock or the data received by the receiver means has stopped for a second predetermined amount of time; and the control means provided in the transmitter is given in advance information on the receiver means provided in the receiver, and specifies the first predetermined amount of time for which the transmission of the data is stopped based on the receiver means information.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

The present invention is directed to a transmitter/receiver, including: a transmitter for transmitting a clock and data; and a receiver for receiving the clock and the data transmitted from the transmitter, wherein: the transmitter includes: transmitter means for transmitting a clock and data, the data being in synchronism with another clock whose frequency is N times that of the clock (where N is a natural number); control means for stopping the transmission of the clock and the data from the transmitter means for a first predetermined amount of time when switching the frequency of the clock from one to another; and read-out means for reading out information on the receiver; the receiver includes: receiver means connected to the transmitter means via a transmission line; reconfiguration means for reconfiguring the receiver means upon detecting that the clock or the data received by the receiver means has stopped for a second predetermined amount of time; and information storing means for storing information on the receiver means or the reconfiguration means; the read-out means provided in the transmitter reads out the information stored in the information storing means; and the control means provided in the transmitter specifies the first predetermined amount of time for which the transmission of the clock and the data is stopped based on the information stored in the information storing means and read out by the read-out means.

The present invention is directed to a transmitter/receiver as set forth above, wherein the information stored in the information storing means provided in the receiver at least includes information on a manufacturer of the receiver means or the reconfiguration means.

The present invention is directed to a transmitter/receiver as set forth above, wherein the first predetermined amount of time is longer than the second predetermined amount of time.

The present invention is directed to a transmitter/receiver as set forth above, wherein the reconfiguration means provided in the receiver performs the reconfiguration by resetting the receiver means.

The present invention is directed to a transmitter/receiver as set forth above, wherein the transmitter means provided in the transmitter transmits the data based on a DVI standard or an HDMI standard.

Thus, according to the present invention, when switching the frequency of the clock from one to another, the transmission of at least one of the clock and the data from the transmitter means is stopped by the control means for a predetermined period of time. Therefore, the receiver no longer needs to follow the change in the clock frequency or to re-synchronize the clock and the data, thereby reducing the occurrence of noise on a TV, or the like, on the receiver side.

### EFFECTS OF THE INVENTION

As described above, according to the present invention, it is possible to reduce the occurrence of noise on a TV, or the like, on the receiver side when switching the frequency of the clock from one to another.

### BRIEF DESCRIPTION OF THE DRAWINGS

FIG. 1 is a block diagram showing a general configuration of a transmitter according to a first embodiment of the present invention.

FIG. 2 is a block diagram showing a general configuration of a transmitter according to a second embodiment of the present invention.

FIG. 3 is a block diagram showing a general configuration of a transmitter according to a third embodiment of the present invention.

FIG. 4 is a block diagram showing a general configuration of a transmitter/receiver according to a fourth embodiment of the present invention.

FIG. 5 is a block diagram showing a general configuration of a transmitter/receiver according to a fifth embodiment of the present invention.

FIG. 6 is a block diagram showing a general configuration of a transmitter/receiver according to a sixth embodiment of the present invention.

FIG. 7 is a block diagram showing a general configuration of a transmitter according to a seventh embodiment of the present invention.

FIG. 8 is a block diagram showing a general configuration of a transmitter according to an eighth embodiment of the present invention.

FIG. 9 is a block diagram showing a general configuration of a transmitter according to a ninth embodiment of the present invention.

FIG. 10 is a block diagram showing a general configuration of a transmitter/receiver according to a tenth embodiment of the present invention.

FIG. 11 is a block diagram showing a general configuration of a transmitter/receiver according to an eleventh embodiment of the present invention.

FIG. 12 is a block diagram showing a general configuration of a transmitter/receiver according to a twelfth embodiment of the present invention.

FIG. 13 is a block diagram showing a general configuration of a transmitter according to a thirteenth embodiment of the present invention.

FIG. 14 is a block diagram showing a general configuration of a transmitter according to a fourteenth embodiment of the present invention.

FIG. 15 is a block diagram showing a general configuration of a transmitter according to a fifteenth embodiment of the present invention.

FIG. 16 is a block diagram showing a general configuration of a transmitter/receiver according to a sixteenth embodiment of the present invention.

FIG. 17 is a block diagram showing a general configuration of a transmitter/receiver according to a seventeenth embodiment of the present invention.

FIG. 18 is a block diagram showing a general configuration of a transmitter/receiver according to an eighteenth embodiment of the present invention.

FIG. 19 is a block diagram showing a general configuration of a conventional transmitter and a conventional transmitter/receiver.

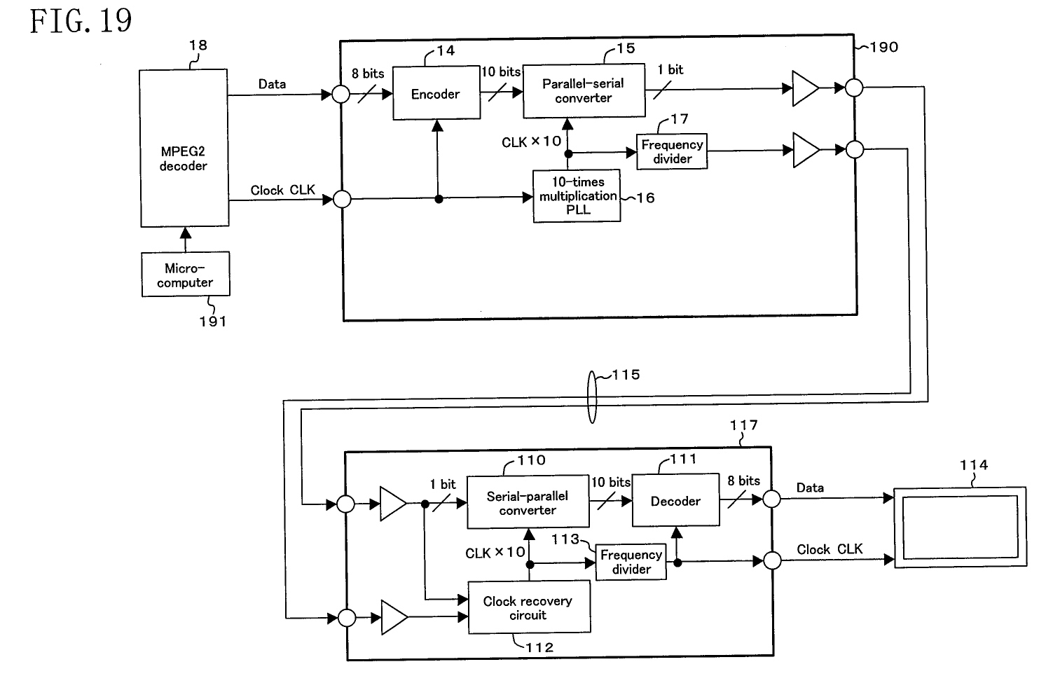

### DESCRIPTION OF REFERENCE NUMERALS

| | |
|---|---|
| 11, 21, 71, 81, 131, 141 | Control circuit (control means) |
| 25, 75, 84, 116, 136, 144 | Transmitter |
| 19, 24, 32, 74, 83, 91, 135, 143, 151 | Microcomputer |
| 42, 102, 162 | Reconfiguration circuit |
| | (reconfiguration means) |
| 43, 103, 117, 163 | Receiver |

### BEST MODE FOR CARRYING OUT THE INVENTION

Transmitters and transmitters/receivers of embodiments of the present invention will now be described with reference to the drawings.

<Clock Controlled>

### First Embodiment

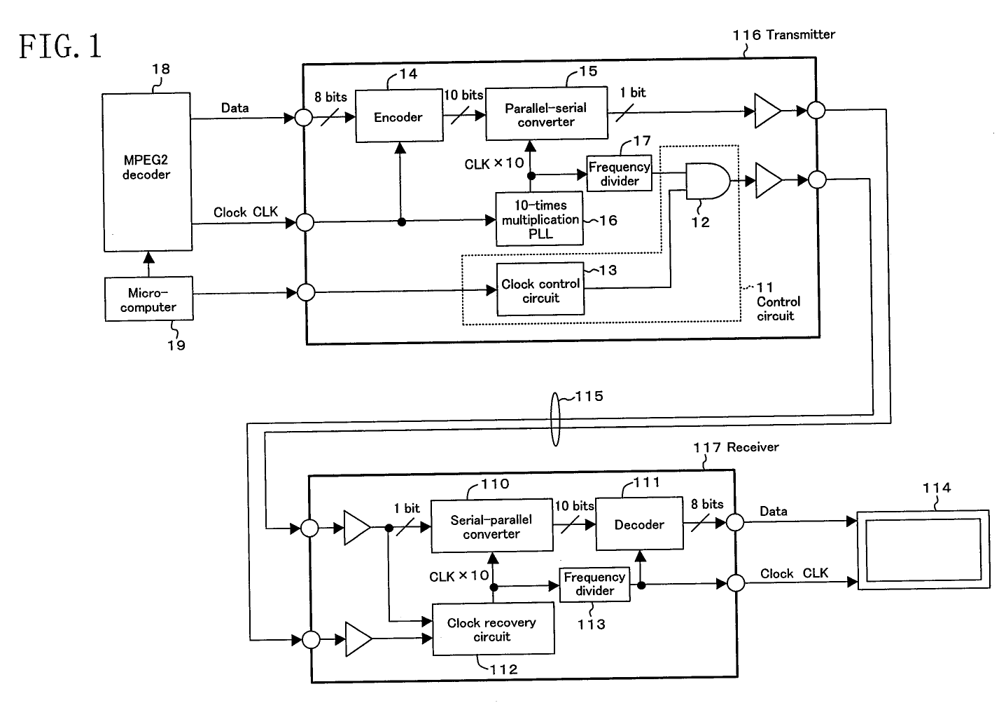

FIG. 1 is a block diagram showing a general configuration of a transmitter according to a first embodiment of the present invention.

In the figure, 11 denotes a control circuit (the control means), 12 a gate circuit, 13 a clock control circuit, 14 an encoder, 15 a parallel-serial converter, 16 a 10-times multiplication PLL, 17 a frequency divider, 18 an MPEG2 decoder, 19 a microcomputer, 110 a serial-parallel converter, 111 a decoder, 112 a clock recovery circuit, 113 a frequency divider, 114 a TV and 115 a cable. Herein, 116 denotes a transmitter and 117 a receiver, wherein the transmitter 116 minus the control circuit 11 corresponds to the transmitter means.

Elements of the same function as those described above in the background art section are denoted by like reference numerals. These elements described above in the background art section will not be further described below. While data are transmitted through three channels in the DVI standard or the HDMI standard, FIG. 1 shows a single-channel transmission in the DVI standard, as an example, for the sake of simplicity. Referring to FIG. 1, the transmitter of the first embodiment will now be described.

Based on an instruction from the microcomputer 19, an SD signal or an HD signal is output from the MPEG2 decoder 18. An HD signal may be produced from an SD signal by an up-converter. Based on an instruction from the microcomputer 19, the clock control circuit 13 controls the gate circuit 12 to stop the output of the clock to the cable 115 for a predetermined period of time.

For example, where the signal is switched from the SD signal to the HD signal, a signal being the trigger for the switching is output from the microcomputer 19 to the clock control circuit 13 at the point of signal transition. The clock control circuit 13 initializes the counter at this trigger and counts the predetermined period of time, thereby outputting to the gate circuit 12 a signal that is “0” during the predetermined period of time and “1” during other periods. The gate circuit 12 outputs “0” during a period in which the output of the clock control circuit 13 is “0”, and thus the clock output is stopped for the predetermined period of time.

With the clock being stopped for the predetermined period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

The predetermined period of time for which the transmission of the clock is stopped varies for each combination of the receiver 117 and the TV 114, and can be set to be equal to the longest one of the possible periods of time.

Therefore, in the present embodiment, a signal switching that entails a change in the frequency such as from the SD signal to the HD signal or from the HD signal to the SD signal can be done while preventing noise from being displayed on the TV 114.

### Second Embodiment

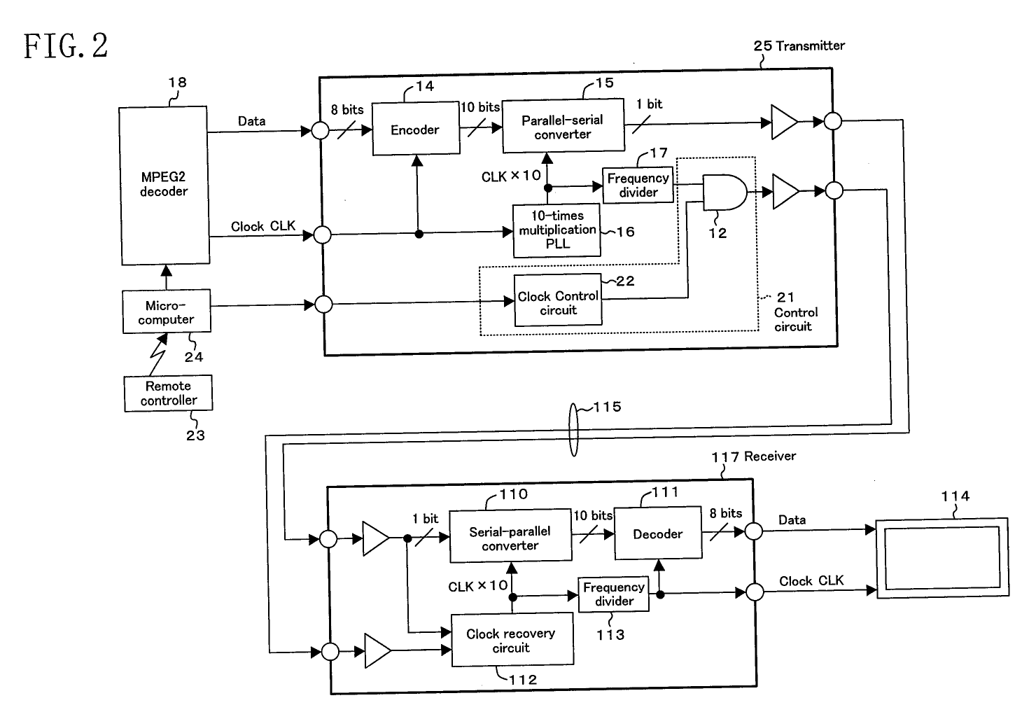

FIG. 2 is a block diagram showing a general configuration of a transmitter according to a second embodiment of the present invention.

In the figure, 21 denotes a control circuit (the control means), 22 a clock control circuit, 23 a remote controller, 24 a microcomputer, and 25 a transmitter. The transmitter 25 minus the control circuit 21 corresponds to the transmitter means. Elements of the same function as those shown in FIG. 1 and those described above in the background art section are denoted by like reference numerals. These elements described above in the first embodiment and the background art section will not be further described below. While data are transmitted through three channels in the DVI standard or the HDMI standard, FIG. 2 shows a single-channel transmission in the DVI standard, as an example, for the sake of simplicity.

Referring to FIG. 2, the transmitter of the second embodiment will now be described.

First, the remote controller 23 is used to give the control circuit 21 information on the product manufacturer (the manufacturer) of the receiver 117. For example, a graphical user interface (hereinafter referred to as a “GUI”) is used to select one from among a list of product manufacturers. The microcomputer 24 processes the GUI to determine the product manufacturer of the receiver 117 and transmits the information to the clock control circuit 22. The clock control circuit 22 has a table defining the correspondence between product manufacturers and clock-holding periods, and determines the clock-holding period according to the specified product manufacturer. This can be done by specifying the count value of the counter for each product manufacturer.

For example, where the signal is switched from the SD signal to the HD signal, a signal being the trigger for the switching is output from the microcomputer 24 to the clock control circuit 22 at the point of signal transition. The clock control circuit 22 initializes the counter at this trigger and counts the specified period of time, thereby outputting to the gate circuit 12 a signal that is “0” during the specified period of time and “1” during other periods. The gate circuit 12 outputs “0” during a period in which the output of the clock control circuit 22 is “0”, and thus the clock output is stopped for the specified period of time. Specifically, it can be stopped for a period of 100 msec for Product Manufacturer A and for a period of 200 msec for Product Manufacturer B.

With the clock being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

Therefore, in the present embodiment, the period for which the clock is stopped is optimized for the receiver 117 and the TV 114, for each product manufacturer. Thus, a signal switching that entails a change in the clock frequency such as from the SD signal to the HD signal or from the HD signal to the SD signal can be done within a short period of time while preventing noise from being displayed on the TV 114.

### Third Embodiment

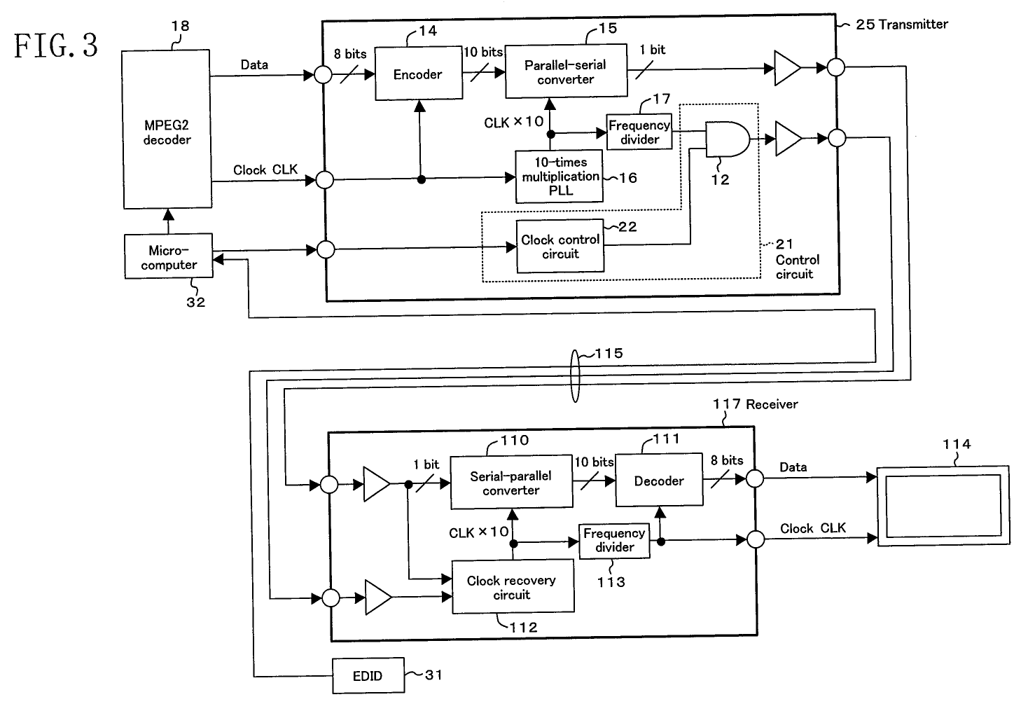

FIG. 3 is a block diagram showing a general configuration of a transmitter according to a third embodiment of the present invention.

In the figure, 31 denotes EDID (Extended Display Identification Data), and 32 a microcomputer. Elements of the same function as those shown in FIGS. 1 and 2 and those described above in the background art section are denoted by like reference numerals. These elements described above in the first and second embodiments and the background art section will not be further described below. While data are transmitted through three channels in the DVI standard or the HDMI standard, FIG. 3 shows a single-channel transmission in the DVI standard, as an example, for the sake of simplicity. Referring to FIG. 3, the transmitter of the third embodiment will now be described.

The EDID 31 stores various information on the receiver 117 and the TV 114. For example, it stores the resolutions with which the TV 114 can produce a display, the audio sample rates with which sound can be output, the product manufacturer, the product number, etc. The microcomputer 32 is provided with a read-out circuit (the read-out means) for accessing the EDID 31 via the cable 115 to obtain various information. The product manufacturer is extracted from among the obtained information for setting the clock control circuit 22. The clock control circuit 22 has a table defining the correspondence between product manufacturers and clock-holding periods, and determines the clock-holding period according to the specified product manufacturer. This is done by specifying the count value of the counter for each product manufacturer.

For example, where the signal is switched from the SD signal to the HD signal, a signal being the trigger for the switching is output from the microcomputer 32 to the clock control circuit 22 at the point of signal transition. The clock control circuit 22 initializes the counter at this trigger and counts the specified period of time, thereby outputting to the gate circuit 12 a signal that is “0” during the specified period of time and “1” during other periods. The gate circuit 12 outputs “0” during a period in which the output of the clock control circuit 22 is “0”, and thus the clock output is stopped for the specified period of time. Specifically, it can be stopped for a period of 100 msec for Product Manufacturer A and for a period of 200 msec for Product Manufacturer B. With the clock being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

Therefore, in the present embodiment, the microcomputer 32 reads out information of the EDID 31 to automatically optimize the period for which the clock is stopped for the receiver 117 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the clock is stopped by holding the clock output at “0” for the predetermined period of time, the clock may be stopped by holding the clock output at “1” for the predetermined period of time, and similar effects can be obtained also when it is held at a high impedance for the predetermined period of time since it will then be fixed to “0” or “1” by the terminator.

Moreover, if the predetermined period of time is shortened to such a degree that a malfunction will not occur even if noise is introduced along the cable 115, a signal switching that entails a change in the frequency can be done quickly while suppressing the display of noise on the TV 114. Alternatively, the predetermined period of time can be optimized based on the length of the cable 115. For example, this can be done by the user of the transmitter 25 or 116 and the receiver 117 specifying the cable length using a GUI, with the clock control circuit 13 or 22 determining the predetermined period of time for each specified cable length.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

### Fourth Embodiment

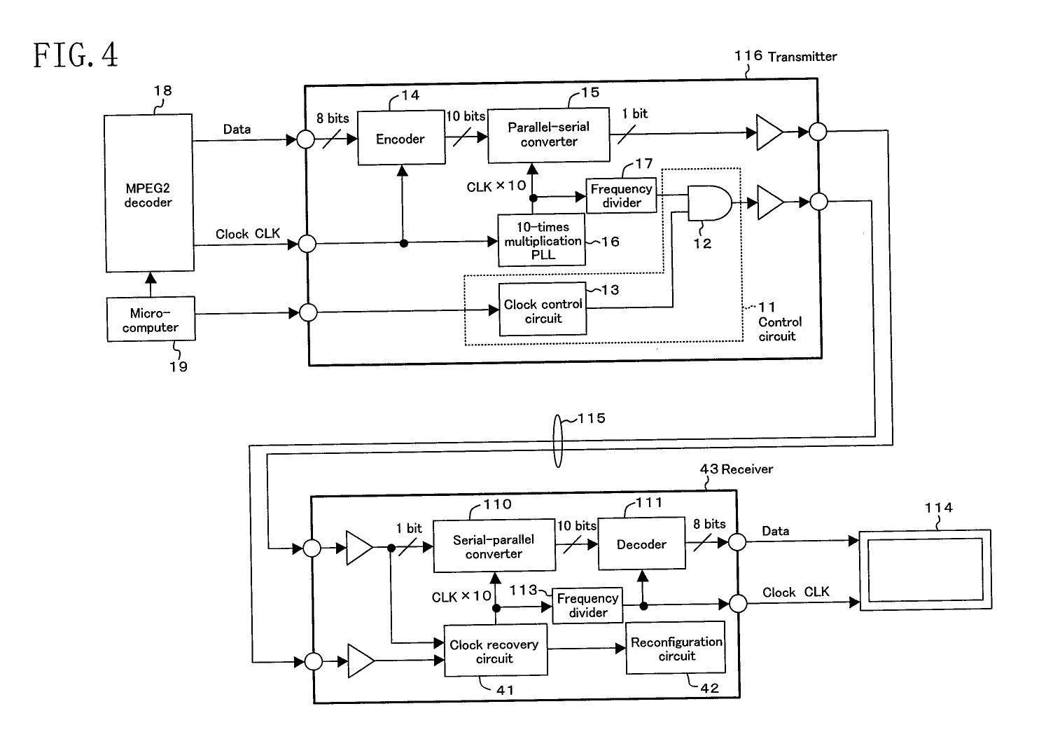

FIG. 4 is a block diagram showing a general configuration of a transmitter/receiver according to a fourth embodiment of the present invention. In the figure, 41 denotes a clock recovery circuit, 42 a reconfiguration circuit (the reconfiguration means) and 43 a receiver, wherein the transmitter 116 and the receiver 43 together form a transmitter/receiver. The receiver 43 minus the reconfiguration circuit 42 corresponds to the receiver means.

Elements of the same function as those shown in FIG. 1 and those described above in the background art section are denoted by like reference numerals. These elements described above in the first embodiment and the background art section will not be further described below. While data are transmitted through three channels in the DVI standard or the HDMI standard, FIG. 4 shows a single-channel transmission in the DVI standard, as an example, for the sake of simplicity.

Referring to FIG. 4, the transmitter/receiver of the fourth embodiment will now be described.

Based on an instruction from the microcomputer 19, an SD signal or an HD signal is output from the MPEG2 decoder 18. An HD signal may be produced from an SD signal by an up-converter. Based on an instruction from the microcomputer 19, the clock control circuit 13 controls the gate circuit 12 to stop the output of the clock to the cable 115 for a first predetermined period of time.

For example, where the signal is switched from the SD signal to the HD signal, a signal being the trigger for the switching is output from the microcomputer 19 to the clock control circuit 13 at the point of signal transition. The clock control circuit 13 initializes the counter at this trigger and counts the first predetermined period of time, thereby outputting to the gate circuit 12 a signal that is “0” during the first predetermined period of time and “1” during other periods. The gate circuit 12 outputs “0” during a period in which the output of the clock control circuit 13 is “0”, and thus the clock output is stopped for the first predetermined period of time.

As the clock is stopped for the first predetermined period of time, the clock recovery circuit 41 detects this and outputs a signal to the reconfiguration circuit 42 indicating that the clock is stopped. The reconfiguration circuit 42 counts the clock-holding state, and resets at least one of the receiver 43 and the TV 114 if the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 116 can reliably notify the receiver 43 of the point of signal transition, thereby reliably initializing the receiver 43. The second predetermined period of time can be set to be long enough so that a malfunction will not occur even if noise is introduced along the cable 115, e.g., 100 msec. The first predetermined period of time can be set to be sufficiently longer than this, e.g., 200 msec.

Therefore, in the present embodiment, a signal switching that entails a change in the frequency such as from the SD signal to the HD signal or from the HD signal to the SD signal can be done while preventing noise from being displayed on the TV 114.

### Fifth Embodiment

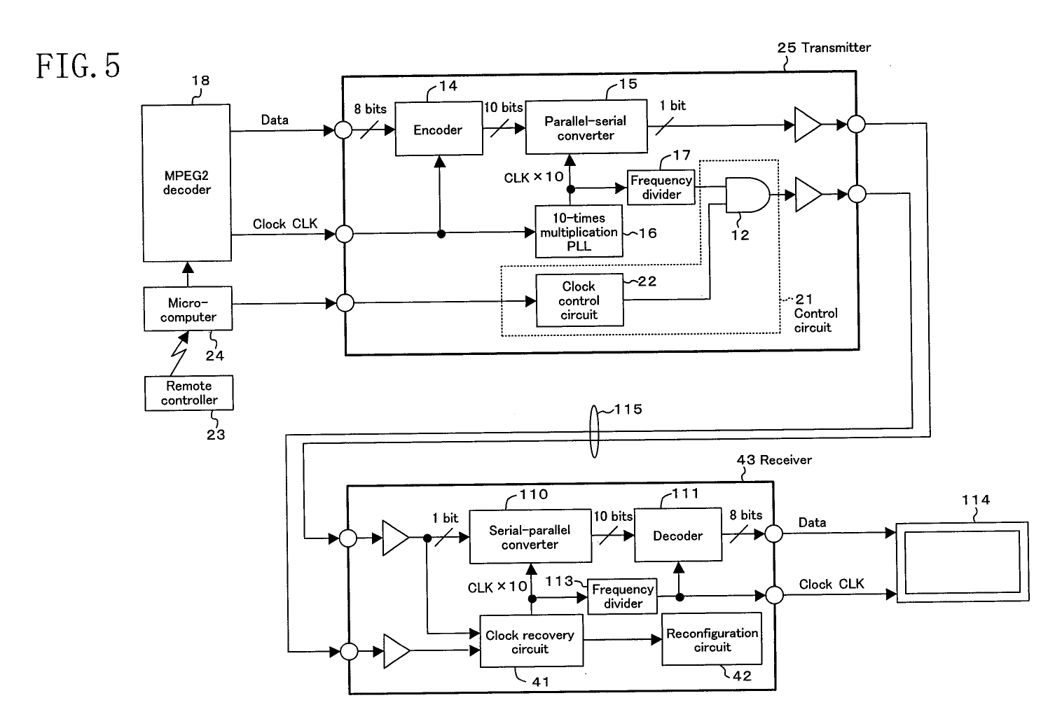

FIG. 5 is a block diagram showing a general configuration of a transmitter/receiver according to a fifth embodiment of the present invention.

In the figure, the transmitter 25 and the receiver 43 together form a transmitter/receiver. Elements of the same function as those shown in FIGS. 1, 2 and 4 and those described above in the background art section are denoted by like reference numerals. These elements described above in the first, second and fourth embodiments and the background art section will not be further described below. While data are transmitted through three channels in the DVI standard or the HDMI standard, FIG. 5 shows a single-channel transmission in the DVI standard, as an example, for the sake of simplicity.

Referring to FIG. 5, the transmitter/receiver of the fifth embodiment will now be described.

First, the remote controller 23 is used to give the control circuit 21 information on the product manufacturer of the receiver 43. For example, a GUI is used to select one from among a list of product manufacturers. The microcomputer 24 processes the GUI to determine the product manufacturer of the receiver 43 and transmits the information to the clock control circuit 22. The clock control circuit 22 has a table defining the correspondence between product manufacturers and clock-holding periods, and determines the clock-holding period according to the specified product manufacturer. This can be done by specifying the count value of the counter for each product manufacturer.

For example, where the signal is switched from the SD signal to the HD signal, a signal being the trigger for the switching is output from the microcomputer 24 to the clock control circuit 22 at the point of signal transition. The clock control circuit 22 initializes the counter at this trigger and counts the specified period of time, thereby outputting to the gate circuit 12 a signal that is “0” during the specified period of time and “1” during other periods. The gate circuit 12 outputs “0” during a period in which the output of the clock control circuit 22 is “0”, and thus the clock output is stopped for the specified first predetermined period of time. Specifically, it can be stopped for a period of 100 msec for Product Manufacturer A and for a period of 200 msec for Product Manufacturer B.

As the clock is stopped for the first predetermined period of time, the clock recovery circuit 41 detects this and outputs a signal to the reconfiguration circuit 42 indicating that the clock is stopped. The reconfiguration circuit 42 counts the clock-holding state, and resets at least one of the receiver 43 and the TV 114 if the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 116 can reliably notify the receiver 43 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 117 of the point of signal transition, thereby reliably initializing the receiver 117 at this point of transition. Therefore, in the present embodiment, the period for which the clock is stopped is optimized for the receiver 117 and the TV 114, for each product manufacturer. Thus, a signal switching that entails a change in the clock frequency such as from the SD signal to the HD signal or from the HD signal to the SD signal can be done within a short period of time while preventing noise from being displayed on the TV 114.

### Sixth Embodiment

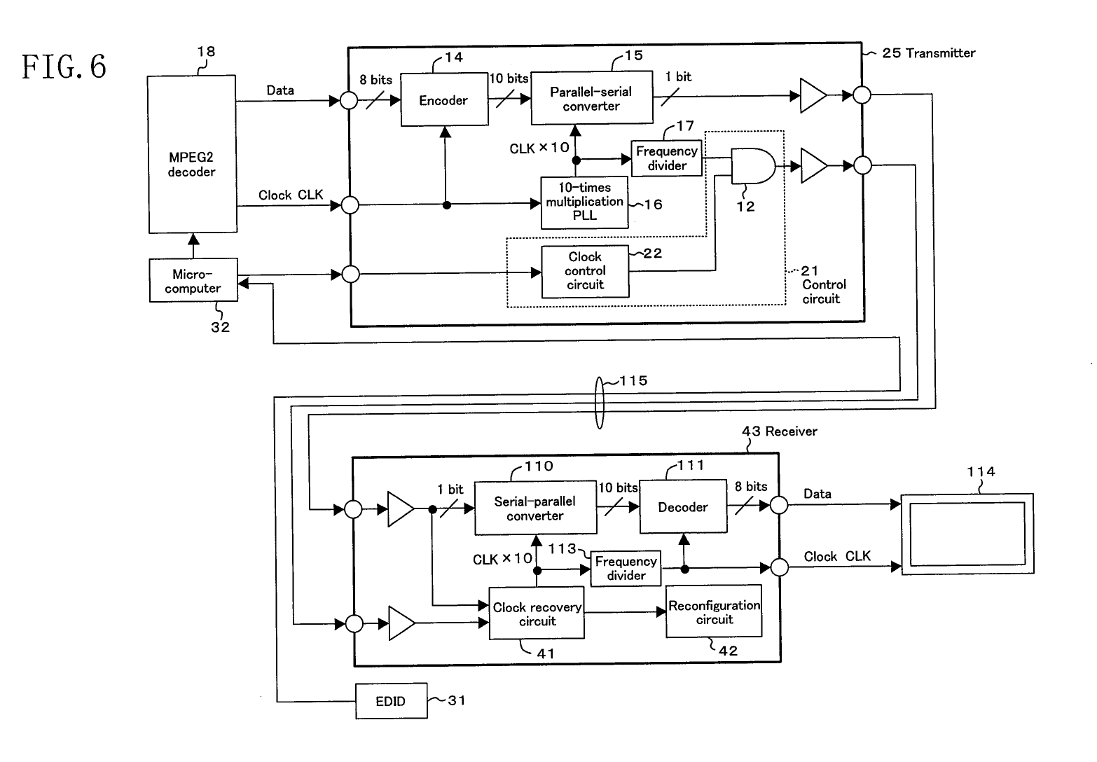

FIG. 6 is a block diagram showing a general configuration of a transmitter/receiver according to a sixth embodiment of the present invention.

In the figure, the transmitter 25 and the receiver 43 together form a transmitter/receiver. Elements of the same function as those shown in FIGS. 1 to 4 and those described above in the background art section are denoted by like reference numerals. These elements described above in the first to fourth embodiments and the background art section will not be further described below. While data are transmitted through three channels in the DVI standard or the HDMI standard, FIG. 6 shows a single-channel transmission in the DVI standard, as an example, for the sake of simplicity. Referring to FIG. 6, the transmitter/receiver of the sixth embodiment will now be described.

The EDID 31 stores various information on the receiver 43 (the receiver means and the reconfiguration means) and the TV 114. For example, it stores the resolutions with which the TV 114 can produce a display, the audio sample rates with which sound can be output, the product manufacturer, the product number, etc. The EDID 31 is stored in the information storing means (not shown) provided in the receiver 43. The microcomputer 32 is provided with a read-out circuit (the read-out means) for accessing the EDID 31 via the cable 115 to obtain various information. The product manufacturer is extracted from among the obtained information, and is set in the clock control circuit 22. The clock control circuit 22 has a table defining the correspondence between product manufacturers and clock-holding periods, and determines the clock-holding period according to the specified product manufacturer. This can be done by specifying the count value of the counter for each product manufacturer.

For example, where the signal is switched from the SD signal to the HD signal, a signal being the trigger for the switching is output from the microcomputer 32 to the clock control circuit 22 at the point of signal transition. The clock control circuit 22 initializes the counter at this trigger and counts the specified period of time, thereby outputting to the gate circuit 12 a signal that is “0” during the specified period of time and “1” during other periods. The gate circuit 12 outputs “0” during a period in which the output of the clock control circuit 22 is “0”, and thus the clock output is stopped for the specified first predetermined period of time. Specifically, it can be stopped for A period of 100 msec for Product Manufacturer A and for a period of 200 msec for Product Manufacturer B.

As the clock is stopped for the first predetermined period of time, the clock recovery circuit 41 detects this and outputs a signal to the reconfiguration circuit 42 indicating that the clock is stopped. The reconfiguration circuit 42 counts the clock-holding state, and resets at least one of the receiver 43 and the TV 114 if the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 25 can reliably notify the receiver 43 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 43 of the point of signal transition, thereby reliably initializing the receiver 43 at this point of transition. Therefore, in the present embodiment, the microcomputer 32 reads out information of the EDID 31 to automatically optimize the period for which the clock is stopped for the receiver 43 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the clock is stopped by holding the clock output at “0” for the predetermined period of time, the clock may be stopped by holding the clock output at “1” for the predetermined period of time, and similar effects can be obtained also when it is held at a high impedance for the predetermined period of time since it will then be fixed to “0” or “1” by the terminator.

If the first predetermined period of time and the second predetermined period of time are shortened to such a degree that a malfunction will not occur even if noise is introduced along the cable 115, a signal switching that entails a change in the frequency can be done quickly while suppressing the display of noise on the TV 114. Alternatively, the first predetermined period of time and the second predetermined period of time may be optimized based on the length of the cable 115. For example, this can be done by the user of the transmitter 25 or 116 and the receiver 43 specifying the cable length using a GUI, with the clock control circuit 22 determining the first predetermined period of time and the reconfiguration circuit 42 determining the second predetermined period of time for each specified cable length.

While the above description is directed to a case where the reconfiguration circuit 42 resets the receiver 43 or the TV 114, the reconfiguration circuit 42 may otherwise reconfigure the receiver 43 or the TV 114 so that the signal switching can be done quickly. For example, the time constant of the filter of the clock recovery circuit 41 may be changed while temporarily stopping the output of the decoder 111 so that it is made to response more quickly than normal only during the signal switching operation. Thus, it is possible to shorten the amount of time for which black screen is displayed on the TV 114.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

<Data Controlled>

### Seventh Embodiment

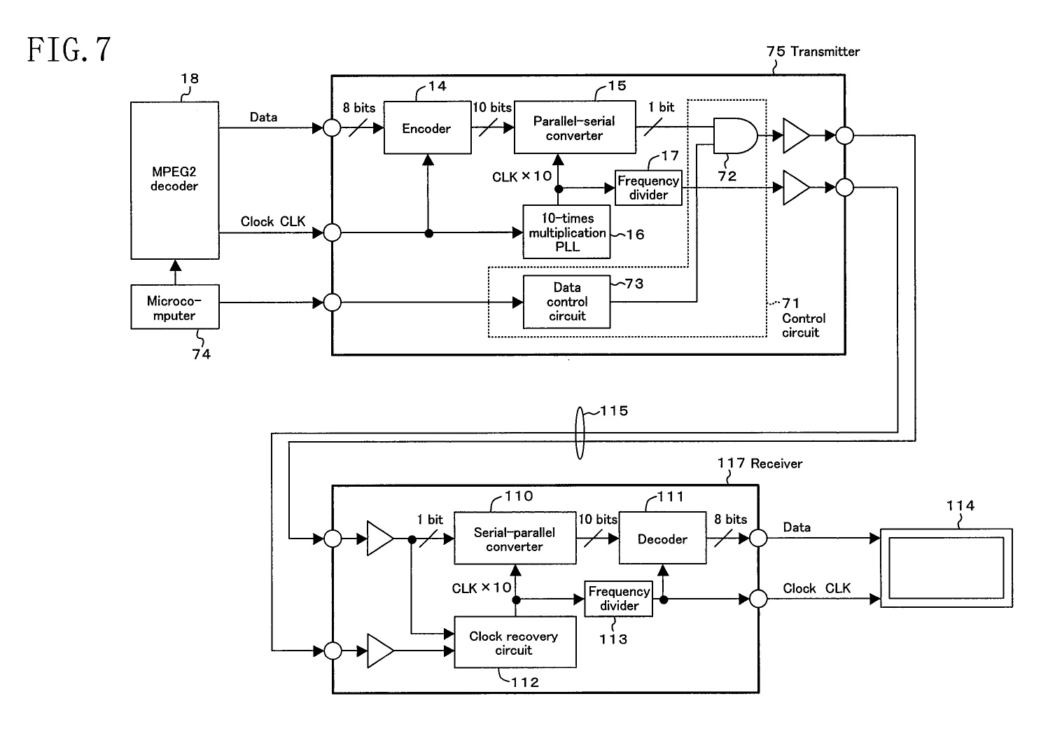

FIG. 7 is a block diagram showing a general configuration of a transmitter according to a seventh embodiment of the present invention.

In the figure, 71 denotes a control circuit (the control means), 72 a gate circuit, 73 a data control circuit, 74 a microcomputer, and 75 a transmitter. The transmitter 75 minus the control circuit 71 corresponds to the transmitter means.

Elements of the same function as those shown in FIG. 1 and those described above in the background art section are denoted by like reference numerals. These elements described above in the first embodiment and the background art section will not be further described below. While data are transmitted through three channels in the DVI standard or the HDMI standard, FIG. 7 shows a single-channel transmission in the DVI standard, as an example, for the sake of simplicity.

Referring to FIG. 7, the transmitter of the seventh embodiment will now be described.

Based on an instruction from the microcomputer 74, an SD signal or an HD signal is output from the MPEG2 decoder 18. An HD signal may be produced from an SD signal by an up-converter. Based on an instruction from the microcomputer 74, the data control circuit 73 controls the gate circuit 72 to stop the output of the data to the cable 115 for a predetermined period of time.

For example, where the signal is switched from the SD signal to the HD signal, a signal being the trigger for the switching is output from the microcomputer 74 to the data control circuit 73 at the point of signal transition. The data control circuit 73 initializes the counter at this trigger and counts the predetermined period of time, thereby outputting to the gate circuit 72 a signal that is “0” during the predetermined period of time and “1” during other periods. The gate circuit 72 outputs “0” during a period in which the output of the data control circuit 73 is “0”, and thus the data output is stopped for the predetermined period of time.

With the data being stopped for the predetermined period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

The predetermined period of time for which the transmission of the data is stopped varies for each combination of the receiver 117 and the TV 114, and can be set to be equal to the longest one of the possible periods of time.

Therefore, in the present embodiment, a signal switching that entails a change in the frequency such as from the SD signal to the HD signal or from the HD signal to the SD signal can be done while preventing noise from being displayed on the TV 114.

### Eighth Embodiment

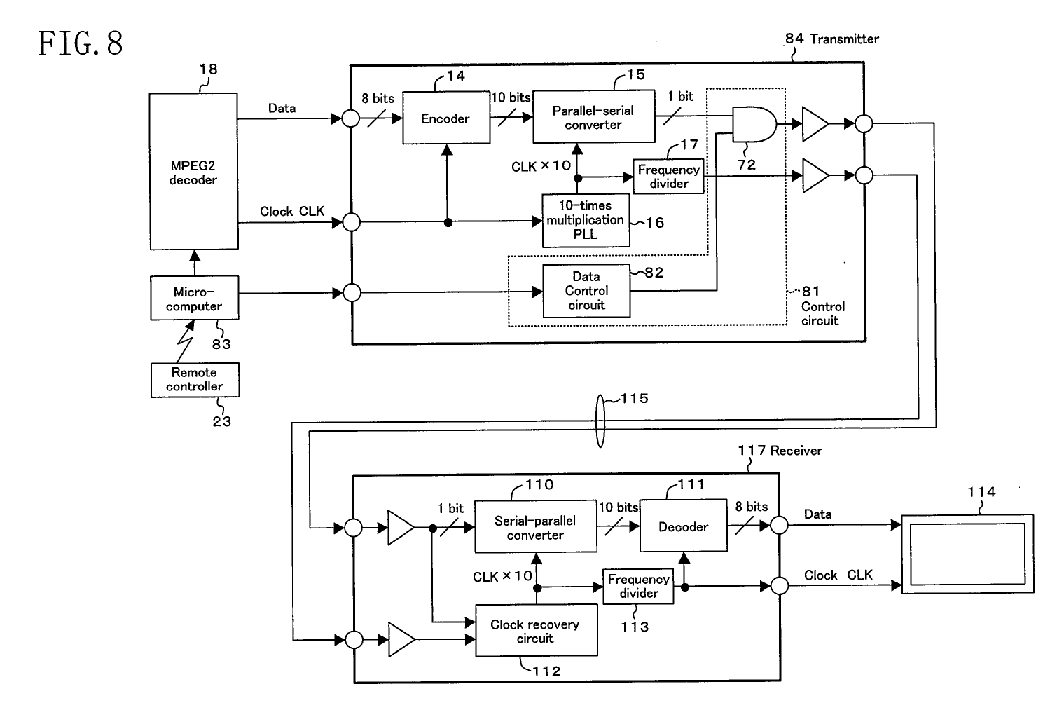

FIG. 8 is a block diagram showing a general configuration of a transmitter according to an eighth embodiment of the present invention.

In the figure, 81 denotes a control circuit (the control means), 82 a data control circuit, 83 a microcomputer, and 84 a transmitter. The transmitter 84 minus the control circuit 81 corresponds to the transmitter means. Elements of the same function as those shown in FIGS. 1, 2 and 7 and those described above in the background art section are denoted by like reference numerals. These elements described above in the first, second and seventh embodiments and the background art section will not be further described below. While data are transmitted through three channels in the DVI standard or the HDMI standard, FIG. 8 shows a single-channel transmission in the DVI standard, as an example, for the sake of simplicity.

First, the remote controller 23 is used to give the control circuit 81 information on the product manufacturer (the manufacturer) of the receiver 117. For example, a GUI is used to select one from among a list of product manufacturers. The microcomputer 83 processes the GUI to determine the product manufacturer of the receiver 117 and transmits the information to the data control circuit 82. The data control circuit 82 has a table defining the correspondence between product manufacturers and data-holding periods, and determines the data-holding period according to the specified product manufacturer. This can be done by specifying the count value of the counter for each product manufacturer.

For example, where the signal is switched from the SD signal to the HD signal, a signal being the trigger for the switching is output from the microcomputer 83 to the data control circuit 82 at the point of signal transition. The data control circuit 82 initializes the counter at this trigger and counts the specified period of time, thereby outputting to the gate circuit 72 a signal that is “0” during the specified period of time and “1” during other periods. The gate circuit 72 outputs “0” during a period in which the output of the data control circuit 82 is “0”, and thus the data output is stopped for the specified period of time. Specifically, it can be stopped for a period of 100 msec for Product Manufacturer A and for a period of 200 msec for Product Manufacturer B.

With the data being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

Therefore, in the present embodiment, the period for which the data is stopped is optimized for the receiver 117 and the TV 114, for each product manufacturer. Thus, a signal switching that entails a change in the clock frequency such as from the SD signal to the HD signal or from the HD signal to the SD signal can be done within a short period of time while preventing noise from being displayed on the TV 114.

### Ninth Embodiment

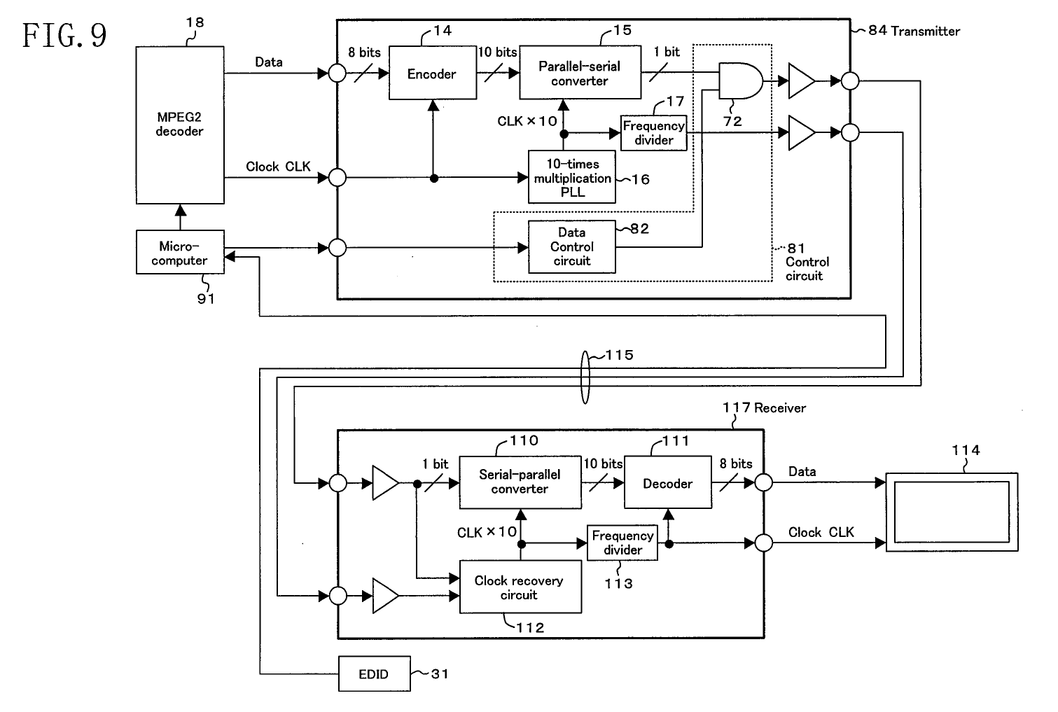

FIG. 9 is a block diagram showing a general configuration of a transmitter according to a ninth embodiment of the present invention.

In the figure, 91 denotes a microcomputer. Elements of the same function as those shown in FIGS. 1, 3, 7 and 8 and those described above in the background art section are denoted by like reference numerals. These elements described above in the first, third, seventh and eighth embodiments and the background art section will not be further described below. While data are transmitted through three channels in the DVI standard or the HDMI standard, FIG. 9 shows a single-channel transmission in the DVI standard, as an example, for the sake of simplicity.

Referring to FIG. 9, the transmitter of the ninth embodiment will now be described.

The EDID 31 stores various information on the receiver 117 and the TV 114. For example, it stores the resolutions with which the TV 114 can produce a display, the audio sample rates with which sound can be output, the product manufacturer, the product number, etc. The microcomputer 91 is provided with a read-out circuit (the read-out means) for accessing the EDID 31 via the cable 115 to obtain various information. The product manufacturer is extracted from among the obtained information, and is set in the data control circuit 82. The data control circuit 82 has a table defining the correspondence between product manufacturers and data-holding periods, and determines the data-holding period according to the specified product manufacturer. This can be done by specifying the count value of the counter for each product manufacturer.

For example, where the signal is switched from the SD signal to the HD signal, a signal being the trigger for the switching is output from the microcomputer 91 to the data control circuit 82 at the point of signal transition. The data control circuit 82 initializes the counter at this trigger and counts the specified period of time, thereby outputting to the gate circuit 72 a signal that is “0” during the specified period of time and “1” during other periods. The gate circuit 72 outputs “0” during a period in which the output of the data control circuit 82 is “0”, and thus the data output is stopped for the specified period of time. Specifically, it can be stopped for a period of 100 msec for Product Manufacturer A and for a period of 200 msec for Product Manufacturer B.

With the data being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed.

Therefore, in the present embodiment, the microcomputer 91 reads out information of the EDID 31 to automatically optimize the period for which the data is stopped for the receiver 117 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the data is stopped by holding the data output at “0” for the predetermined period of time, the data may be stopped by holding the data output at “1” for the predetermined period of time, and similar effects can be obtained also when it is held at a high impedance for the predetermined period of time since it will then be fixed to “0” or “1” by the terminator.

Moreover, if the predetermined period of time is shortened to such a degree that a malfunction will not occur even if noise is introduced along the cable 115, a signal switching that entails a change in the frequency can be done quickly while suppressing the display of noise on the TV 114. Alternatively, the predetermined period of time can be optimized based on the length of the cable 115. For example, this can be done by the user of the transmitter 75 or 84 and the receiver 117 specifying the cable length using a GUI, with the data control circuit 73 or 82 determining the predetermined period of time for each specified cable length.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

### Tenth Embodiment

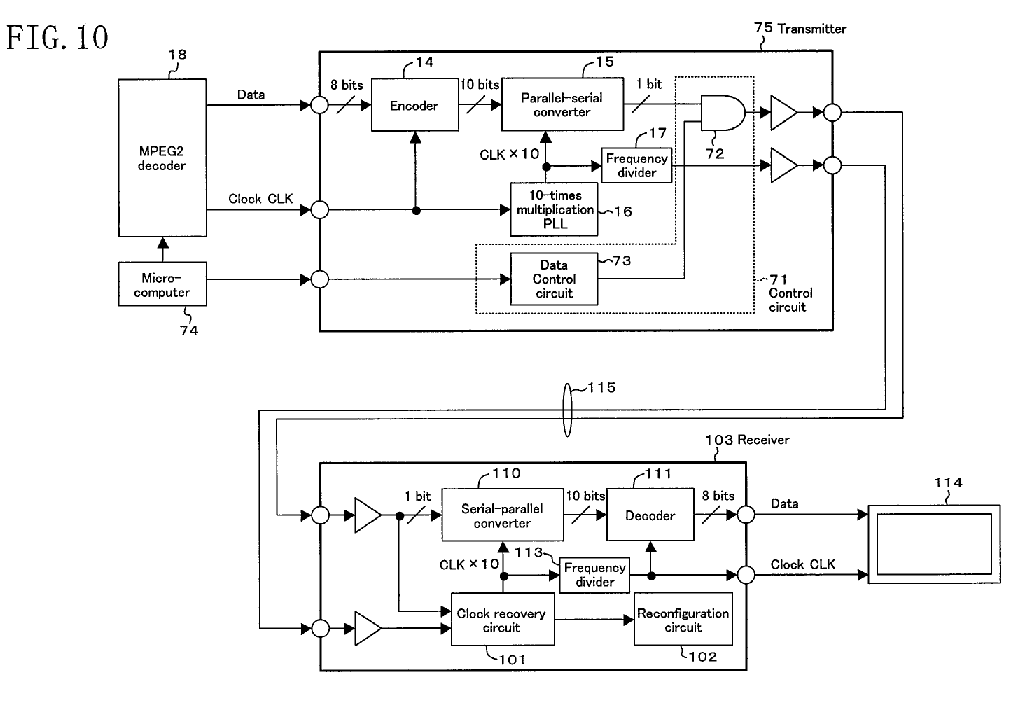

FIG. 10 is a block diagram showing a general configuration of a transmitter/receiver according to a tenth embodiment of the present invention.

In the figure, 101 denotes a clock recovery circuit, 102 a reconfiguration circuit (the reconfiguration means) and 103 a receiver, wherein the transmitter 75 and the receiver 103 together form a transmitter/receiver. The receiver 103 minus the reconfiguration circuit 102 corresponds to the receiver means.

Elements of the same function as those shown in FIGS. 1 and 7 and those described above in the background art section are denoted by like reference numerals. These elements described above in the first and seventh embodiments and the background art section will not be further described below. While data are transmitted through three channels in the DVI standard or the HDMI standard, FIG. 10 shows a single-channel transmission in the DVI standard, as an example, for the sake of simplicity.

Referring to FIG. 10, the transmitter/receiver of the tenth embodiment will now be described.

Based on an instruction from the microcomputer 74, an SD signal or an HD signal is output from the MPEG2 decoder 18. An HD signal may be produced from an SD signal by an up-converter. Based on an instruction from the microcomputer 74, the data control circuit 73 controls the gate circuit 72 to stop the output of the data to the cable 115 for a first predetermined period of time.

For example, where the signal is switched from the SD signal to the HD signal, a signal being the trigger for the switching is output from the microcomputer 74 to the data control circuit 73 at the point of signal transition. The data control circuit 73 initializes the counter at this trigger and counts the first predetermined period of time, thereby outputting to the gate circuit 72 a signal that is “0” during the first predetermined period of time and “1” during other periods. The gate circuit 72 outputs “0” during a period in which the output of the data control circuit 73 is “0”, and thus the data output is stopped for the first predetermined period of time.

As the data is stopped for the first predetermined period of time, the clock recovery circuit 101 detects this and outputs a signal to the reconfiguration circuit 102 indicating that the data is stopped. The reconfiguration circuit 102 counts the data-holding state, and resets at least one of the receiver 103 and the TV 114 if the data has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 75 can reliably notify the receiver 103 of the point of signal transition, thereby reliably initializing the receiver 103. The second predetermined period of time can be set to be long enough so that a malfunction will not occur even if noise is introduced along the cable 115, e.g., 100 msec. The first predetermined period of time can be set to be sufficiently longer than this, e.g., 200 msec.

Therefore, in the present embodiment, a signal switching that entails a change in the frequency such as from the SD signal to the HD signal or from the HD signal to the SD signal can be done while preventing noise from being displayed on the TV 114.

### Eleventh Embodiment

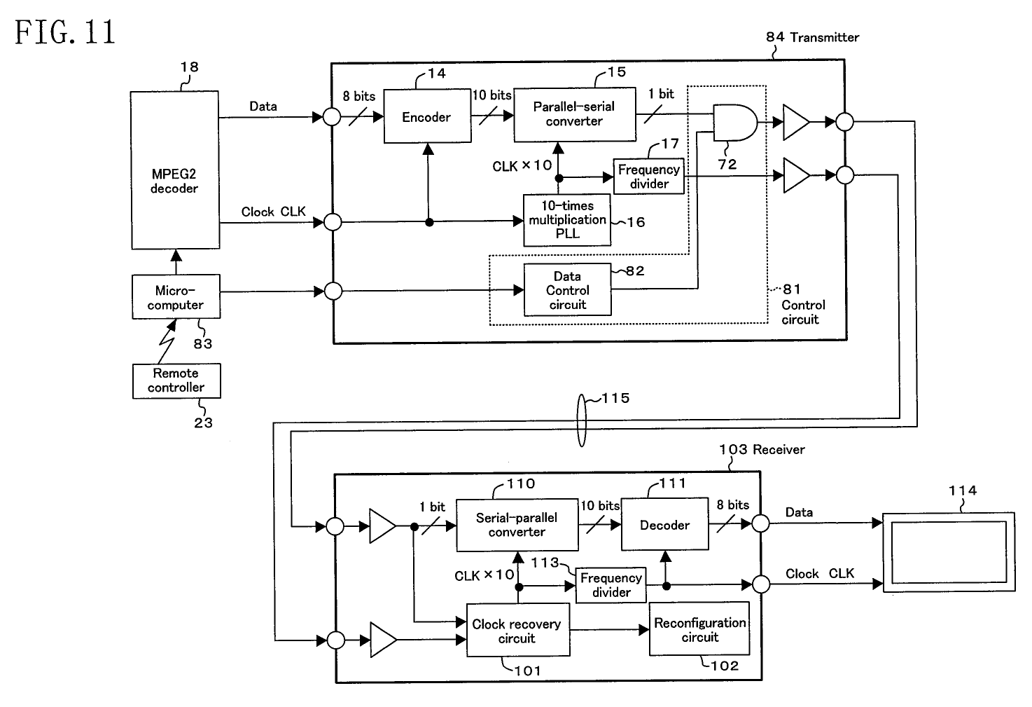

FIG. 11 is a block diagram showing a general configuration of a transmitter/receiver according to an eleventh embodiment of the present invention.

In the figure, the transmitter 84 and the receiver 103 together form a transmitter/receiver. Elements of the same function as those shown in FIGS. 1, 2, 7, 8 and 10 and those described above in the background art section are denoted by like reference numerals. These elements described above in the first, second, seventh, eighth and tenth embodiments and the background art section will not be further described below. While data are transmitted through three channels in the DVI standard or the HDMI standard, FIG. 11 shows a single-channel transmission in the DVI standard, as an example, for the sake of simplicity.

Referring to FIG. 11, the transmitter/receiver of the eleventh embodiment will now be described.

First, the remote controller 23 is used to give the control circuit 81 information on the product manufacturer of the receiver 103. For example, a GUI is used to select one from among a list of product manufacturers. The microcomputer 83 processes the GUI to determine the product manufacturer of the receiver 103 and transmits the information to the data control circuit 82. The data control circuit 82 has a table defining the correspondence between product manufacturers and clock-holding periods, and determines the clock-holding period according to the specified product manufacturer. This can be done by specifying the count value of the counter for each product manufacturer.

For example, where the signal is switched from the SD signal to the HD signal, a signal being the trigger for the switching is output from the microcomputer 83 to the data control circuit 82 at the point of signal transition. The data control circuit 82 initializes the counter at this trigger and counts the specified period of time, thereby outputting to the gate circuit 72 a signal that is “0” during the specified period of time and “1” during other periods. The gate circuit 72 outputs “0” during a period in which the output of the data control circuit 82 is “0”, and thus the data output is stopped for the specified first predetermined period of time. Specifically, it can be stopped for a period of 100 msec for Product Manufacturer A and for a period of 200 msec for Product Manufacturer B.

As the data is stopped for the first predetermined period of time, the clock recovery circuit 101 detects this and outputs a signal to the reconfiguration circuit 102 indicating that the data is stopped. The reconfiguration circuit 102 counts the data-holding state, and resets at least one of the receiver 103 and the TV 114 if the data has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 84 can reliably notify the receiver 103 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 103 of the point of signal transition, thereby reliably initializing the receiver 103 at this point of transition.

Therefore, in the present embodiment, the period for which the data is stopped is optimized for the receiver 103 and the TV 114, for each product manufacturer. Thus, a signal switching that entails a change in the clock frequency such as from the SD signal to the HD signal or from the HD signal to the SD signal can be done within a short period of time while preventing noise from being displayed on the TV 114.

### Twelfth Embodiment

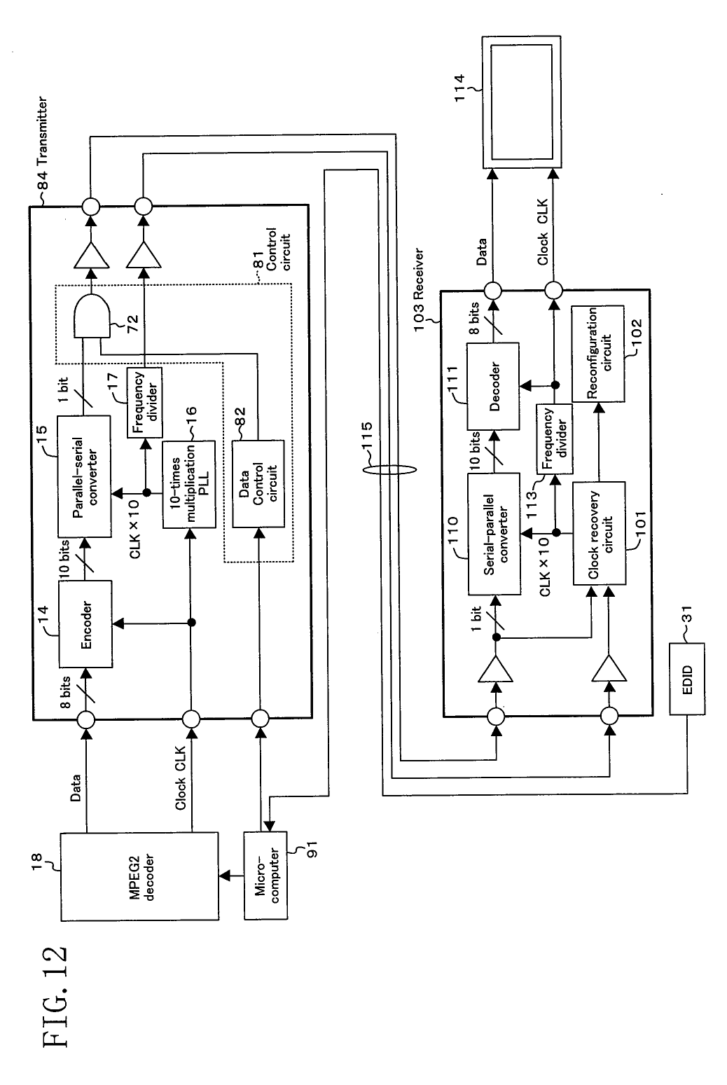

FIG. 12 is a block diagram showing a general configuration of a transmitter/receiver according to a twelfth embodiment of the present invention.

The transmitter 84 and the receiver 103 together form a transmitter/receiver. Elements of the same function as those shown in FIGS. 1, 3, 7 to 10 and those described above in the background art section are denoted by like reference numerals. These elements described above in the first, third and seventh to tenth embodiments and the background art section will not be further described below. While data are transmitted through three channels in the DVI standard or the HDMI standard, FIG. 12 shows a single-channel transmission in the DVI standard, as an example, for the sake of simplicity.

Referring to FIG. 12, the transmitter/receiver of the twelfth embodiment will now be described.

The EDID 31 stores various information on the receiver 103 (the receiver means and the reconfiguration means) and the TV 114. For example, it stores the resolutions with which the TV 114 can produce a display, the audio sample rates with which sound can be output, the product manufacturer, the product number, etc. The EDID 31 is stored in the information storing means (not shown) provided in the receiver 103. The microcomputer 91 is provided with a read-out circuit (the read-out means) for accessing the EDID 31 via the cable 115 to obtain various information. The product manufacturer is extracted from among the obtained information, and is set in the data control circuit 82. The data control circuit 82 has a table defining the correspondence between product manufacturers and data-holding periods, and determines the data-holding period according to the specified product manufacturer. This can be done by specifying the count value of the counter for each product manufacturer.

For example, where the signal is switched from the SD signal to the HD signal, a signal being the trigger for the switching is output from the microcomputer 91 to the data control circuit 82 at the point of signal transition. The data control circuit 82 initializes the counter at this trigger and counts the specified period of time, thereby outputting to the gate circuit 72 a signal that is “0” during the specified period of time and “1” during other periods. The gate circuit 72 outputs “0” during a period in which the output of the data control circuit 82 is “0”, and thus the data output is stopped for the specified first predetermined period of time. Specifically, it can be stopped for a period of 100 msec for Product Manufacturer A and for a period of 200 msec for Product Manufacturer B.

As the data is stopped for the first predetermined period of time, the clock recovery circuit 101 detects this and outputs a signal to the reconfiguration circuit 102 indicating that the data is stopped. The reconfiguration circuit 102 counts the data-holding state, and resets at least one of the receiver 103 and the TV 114 if the data has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 84 can reliably notify the receiver 103 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 103 of the point of signal transition, thereby reliably initializing the receiver 103 at this point of transition. Therefore, in the present embodiment, the microcomputer 91 reads out information of the EDID 31 to automatically optimize the period for which the data is stopped for the receiver 103 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the data is stopped by holding the data output at “0” for the predetermined period of time, the data may be stopped by holding the data output at “1” for the predetermined period of time. Similar effects can be obtained also when it is held at a high impedance for the predetermined period of time since it will then be fixed to “0” or “1” by the terminator.

If the first predetermined period of time and the second predetermined period of time are shortened to such a degree that a malfunction will not occur even if noise is introduced along the cable 115, a signal switching that entails a change in the frequency can be done quickly while suppressing the display of noise on the TV 114. Alternatively, the first predetermined period of time and the second predetermined period of time may be optimized based on the length of the cable 115. For example, this can be done by the user of the transmitter 75 or 84 and the receiver 103 specifying the cable length using a GUI, with the data control circuit 73 or 82 determining the first predetermined period of time and the reconfiguration circuit 102 determining the second predetermined period of time for each specified cable length.

While the above description is directed to a case where the reconfiguration circuit 102 resets the receiver 103 or the TV 114, the reconfiguration circuit 102 may otherwise reconfigure the receiver 103 or the TV 114 so that the signal switching can be done quickly. For example, the time constant of the filter of the clock recovery circuit 101 may be changed while temporarily stopping the output of the decoder 111 so that it is made to response more quickly than normal only during the signal switching operation. Thus, it is possible to shorten the amount of time for which black screen is displayed on the TV 114.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

<Clock and Data Controlled>

### Thirteenth Embodiment

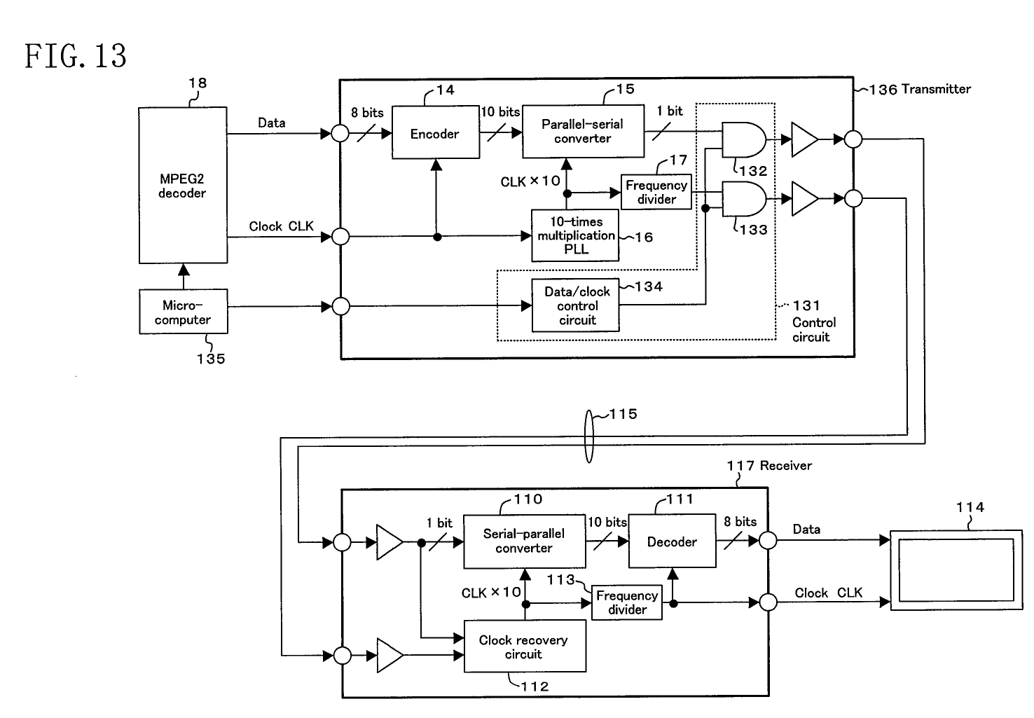

FIG. 13 is a block diagram showing a general configuration of a transmitter according to a thirteenth embodiment of the present invention.

In the figure, 131 denotes a control circuit (the control means), 132 and 133 gate circuits, 134 a data/clock control circuit, 135 a microcomputer, and 136 a transmitter. The transmitter 136 minus the control circuit 131 corresponds to the transmitter means.

Elements of the same function as those shown in FIG. 1 and those described above in the background art section are denoted by like reference numerals. These elements described above in the first embodiment and the background art section will not be further described below. While data are transmitted through three channels in the DVI standard or the HDMI standard, FIG. 13 shows a single-channel transmission in the DVI standard, as an example, for the sake of simplicity.

Referring to FIG. 13, the transmitter of the thirteenth embodiment will now be described.

Based on an instruction from the microcomputer 135, an SD signal or an HD signal is output from the MPEG2 decoder 18. An HD signal may be produced from an SD signal by an up-converter. Based on an instruction from the microcomputer 135, the data/clock control circuit 134 controls the gate circuits 132 and 133 to stop the output of the data and the clock to the cable 115 for a predetermined period of time.

For example, where the signal is switched from the SD signal to the HD signal, a signal being the trigger for the switching is output from the microcomputer 135 to the data/clock control circuit 134 at the point of signal transition. The data/clock control circuit 134 initializes the counter at this trigger and counts the predetermined period of time, thereby outputting to the gate circuits 132 and 133 a signal that is “0” during the predetermined period of time and “1” during other periods. The gate circuits 132 and 133 output “0” during a period in which the output of the data/clock control circuit 134 is “0”, and thus the output of the data and the clock is stopped for the predetermined period of time.

With the data and the clock being stopped for the predetermined period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed. As the data and the clock are both stopped, it is possible to prevent a malfunction of the protection function of the receiver 117 due to noise.

The predetermined period of time for which the transmission of the data and the clock is stopped varies for each combination of the receiver 117 and the TV 114, and can be set to be equal to the longest one of the possible periods of time.

Therefore, in the present embodiment, a signal switching that entails a change in the frequency such as from the SD signal to the HD signal or from the HD signal to the SD signal can be done while preventing noise from being displayed on the TV 114.

### Fourteenth Embodiment

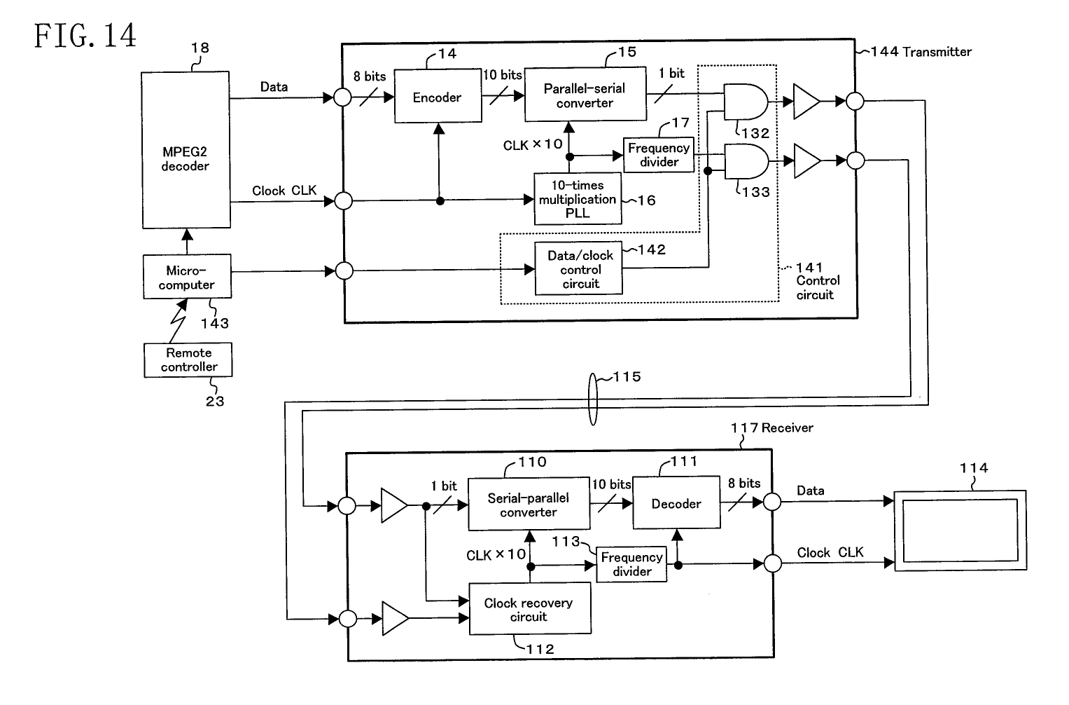

FIG. 14 is a block diagram showing a general configuration of a transmitter according to a fourteenth embodiment of the present invention.

In the figure, 141 denotes a control circuit (the control means), 142 a data/clock control circuit, 143 a microcomputer, and 144 a transmitter. The transmitter 144 minus the control circuit 141 corresponds to the transmitter means.

Elements of the same function as those shown in FIGS. 1, 2 and 13 and those described above in the background art section are denoted by like reference numerals. These elements described above in the first, second and thirteenth embodiments and the background art section will not be further described below. While data are transmitted through three channels in the DVI standard or the HDMI standard, FIG. 14 shows a single-channel transmission in the DVI standard, as an example, for the sake of simplicity.

Referring to FIG. 14, the transmitter of the fourteenth embodiment will now be described.

First, the remote controller 23 is used to give the control circuit 141 information on the product manufacturer (the manufacturer) of the receiver 117. For example, a GUI is used to select one from among a list of product manufacturers. The microcomputer 143 processes the GUI to determine the product manufacturer of the receiver 117 and transmits the information to the data/clock control circuit 142. The data/clock control circuit 142 has a table defining the correspondence between product manufacturers and data- and clock-holding periods, and determines the data- and clock-holding period according to the specified product manufacturer. This can be done by specifying the count value of the counter for each product manufacturer.

For example, where the signal is switched from the SD signal to the HD signal, a signal being the trigger for the switching is output from the microcomputer 143 to the data/clock control circuit 142 at the point of signal transition. The data/clock control circuit 142 initializes the counter at this trigger and counts the specified period of time, thereby outputting to the gate circuits 132 and 133 a signal that is “0” during the specified period of time and “1” during other periods. The gate circuits 132 and 133 output “0” during a period in which the output of the data/clock control circuit 142 is “0”, and thus the output of the data and the clock is stopped for the specified period of time. Specifically, they can be stopped for a period of 100 msec for Product Manufacturer A and for a period of 200 msec for Product Manufacturer B.

With the data and the clock being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed. As the data and the clock are both stopped, it is possible to prevent a malfunction of the protection function of the receiver 117 due to noise.

Therefore, in the present embodiment, the period for which the clock and the data are stopped is optimized for the receiver 117 and the TV 114, for each product manufacturer. Thus, a signal switching that entails a change in the clock frequency such as from the SD signal to the HD signal or from the HD signal to the SD signal can be done within a short period of time while preventing noise from being displayed on the TV 114.

### Fifteenth Embodiment

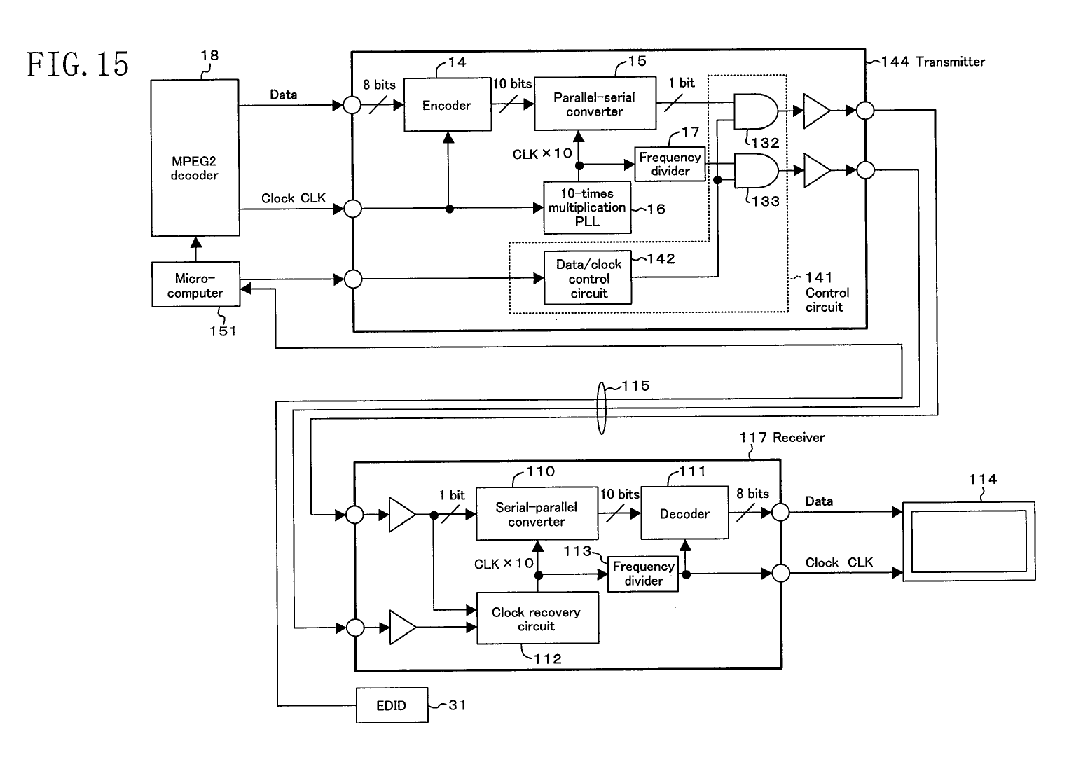

FIG. 15 is a block diagram showing a general configuration of a transmitter according to a fifteenth embodiment of the present invention.

In the figure, 151 denotes a microcomputer. Elements of the same function as those shown in FIGS. 1, 3, 13 and 14 and those described above in the background art section are denoted by like reference numerals. These elements described above in the first, third, thirteenth and fourteenth embodiments and the background art section will not be further described below. While data are transmitted through three channels in the DVI standard or the HDMI standard, FIG. 15 shows a single-channel transmission in the DVI standard, as an example, for the sake of simplicity.

Referring to FIG. 15, the transmitter of the fifteenth embodiment will now be described.

The EDID 31 stores various information on the receiver 117 and the TV 114. For example, it stores the resolutions with which the TV 114 can produce a display, the audio sample rates with which sound can be output, the product manufacturer, the product number, etc. The microcomputer 151 is provided with a read-out circuit (the read-out means) for accessing the EDID 31 via the cable 115 to obtain various information. The product manufacturer is extracted from among the obtained information, and is set in the data/clock control circuit 142. The data/clock control circuit 142 has a table defining the correspondence between product manufacturers and data- and clock-holding periods, and determines the data- and clock-holding period according to the specified product manufacturer. This can be done by specifying the count value of the counter for each product manufacturer.

For example, where the signal is switched from the SD signal to the HD signal, a signal being the trigger for the switching is output from the microcomputer 151 to the data/clock control circuit 142 at the point of signal transition. The data/clock control circuit 142 initializes the counter at this trigger and counts the specified period of time, thereby outputting to the gate circuits 132 and 133 a signal that is “0” during the specified period of time and “1” during other periods. The gate circuits 132 and 133 output “0” during a period in which the output of the data/clock control circuit 142 is “0”, and thus the output of the data and the clock is stopped for the specified period of time. Specifically, it can be stopped for a period of 100 msec for Product Manufacturer A and for a period of 200 msec for Product Manufacturer B.

With the data and the clock being stopped for the specified period of time, it is as if the cable 115 were disconnected, for the receiver 117 and the TV 114. Therefore, the protection function is activated and the display on the TV 114 is automatically turned OFF, thus preventing noise from being displayed at the point of transition from the SD signal to the HD signal. For example, the TV 114 detects the disappearance of the horizontal synchronization signal or the vertical synchronization signal of the video signal and forcibly turns the display to black screen, thus preventing unpleasant noise from being displayed. As the data and the clock are both stopped, it is possible to prevent a malfunction of the protection function of the receiver 117 due to noise.

Therefore, in the present embodiment, the microcomputer 151 reads out information of the EDID 31 to automatically optimize the period for which the data and the clock are stopped for the receiver 117 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the data and the clock are stopped by holding the output of the data and the clock at “0” for the predetermined period of time, the data and the clock may be stopped by holding the output of the data and the clock at “1” for the predetermined period of time. Similar effects can be obtained also when it is held at a high impedance for the predetermined period of time since it will then be fixed to “0” or “1” by the terminator.

Moreover, if the predetermined period of time is shortened to such a degree that a malfunction will not occur even if noise is introduced along the cable 115, a signal switching that entails a change in the frequency can be done quickly while suppressing the display of noise on the TV 114. Alternatively, the predetermined period of time can be optimized based on the length of the cable 115. For example, this can be done by the user of the transmitter 136 or 144 and the receiver 117 specifying the cable length using a GUI, with the data/clock control circuit 134 or 142 determining the predetermined period of time for each specified cable length.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

### Sixteenth Embodiment

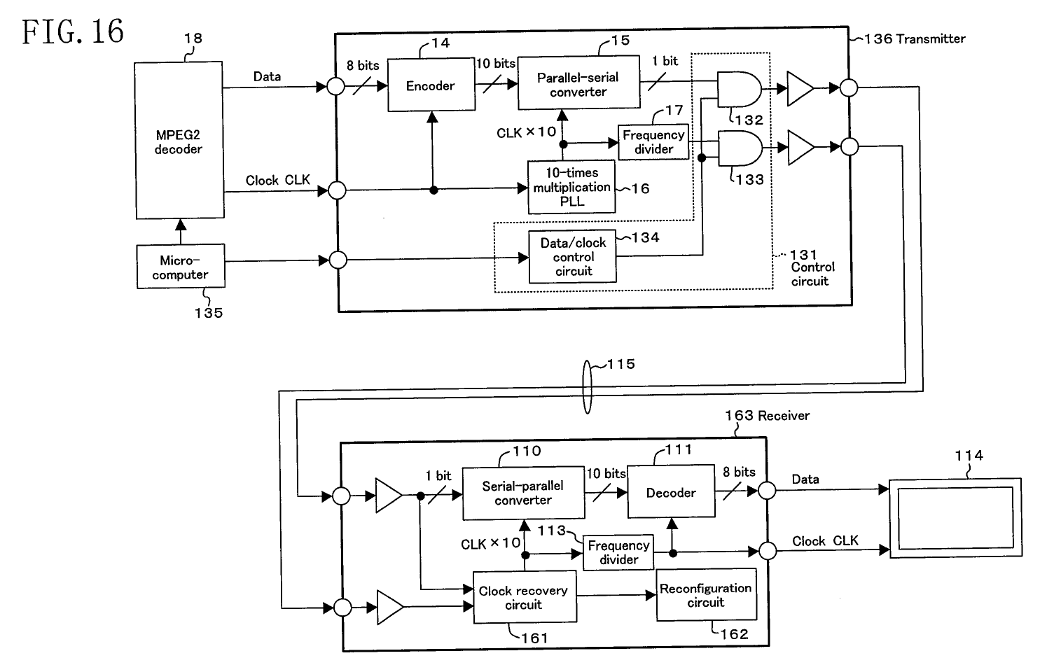

FIG. 16 is a block diagram showing a general configuration of a transmitter/receiver according to a sixteenth embodiment of the present invention.

In the figure, 161 denotes a clock recovery circuit, 162 a reconfiguration circuit (the reconfiguration means) and 163 a receiver, wherein the transmitter 136 and the receiver 163 together form a transmitter/receiver. The receiver 163 minus the reconfiguration circuit 162 corresponds to the receiver means.

Elements of the same function as those shown in FIGS. 1 and 13 and those described above in the background art section are denoted by like reference numerals. These elements described above in the first and thirteenth embodiments and the background art section will not be further described below. While data are transmitted through three channels in the DVI standard or the HDMI standard, FIG. 16 shows a single-channel transmission in the DVI standard, as an example, for the sake of simplicity.

Referring to FIG. 16, the transmitter/receiver of the sixteenth embodiment will now be described.

Based on an instruction from the microcomputer 135, an SD signal or an HD signal is output from the MPEG2 decoder 18. An HD signal may be produced from an SD signal by an up-converter. Based on an instruction from the microcomputer 135, the data/clock control circuit 134 controls the gate circuits 132 and 133 to stop the output of the data and the clock to the cable 115 for a first predetermined period of time.

For example, where the signal is switched from the SD signal to the HD signal, a signal being the trigger for the switching is output from the microcomputer 135 to the data/clock control circuit 134 at the point of signal transition. The data/clock control circuit 134 initializes the counter at this trigger and counts the first predetermined period of time, thereby outputting to the gate circuits 132 and 133 a signal that is “0” during the first predetermined period of time and “1” during other periods. The gate circuits 132 and 133 output “0” during a period in which the output of the data/clock control circuit 134 is “0”, and thus the output of the data and the clock is stopped for the first predetermined period of time.

As the data and the clock are stopped for the first predetermined period of time, the clock recovery circuit 161 detects this and outputs a signal to the reconfiguration circuit 162 indicating that the data or the clock is stopped. If it detects that the data and the clock are both stopped, it is possible to prevent an erroneous detection by the clock recovery circuit 161 due to noise. The reconfiguration circuit 162 counts the data- or clock-holding state, and resets at least one of the receiver 163 and the TV 114 if the data or the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 136 can reliably notify the receiver 163 of the point of signal transition, thereby reliably initializing the receiver 163. The second predetermined period of time can be set to be long enough so that a malfunction will not occur even if noise is introduced along the cable 115, e.g., 100 msec. The first predetermined period of time can be set to be sufficiently longer than this, e.g., 200 msec.

Therefore, in the present embodiment, a signal switching that entails a change in the frequency such as from the SD signal to the HD signal or from the HD signal to the SD signal can be done while preventing noise from being displayed on the TV 114.

### Seventeenth Embodiment

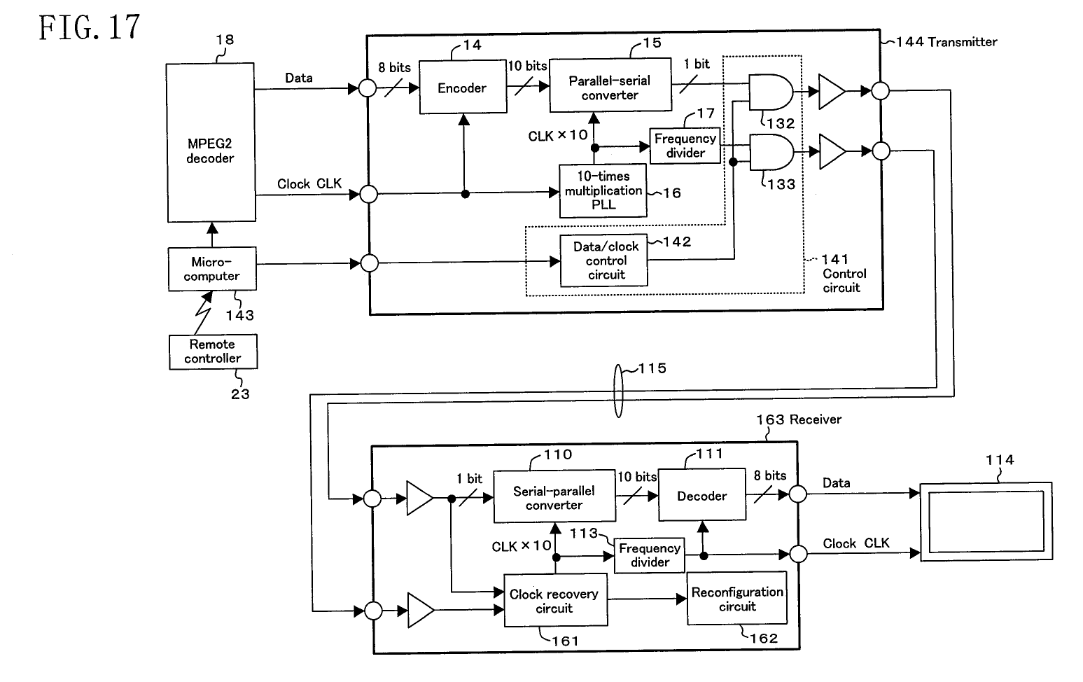

FIG. 17 is a block diagram showing a general configuration of a transmitter/receiver according to a seventeenth embodiment of the present invention.

The transmitter 144 and the receiver 163 together form a transmitter/receiver. Elements of the same function as those shown in FIGS. 1, 2, 13, 14 and 16 and those described above in the background art section are denoted by like reference numerals. These elements described above in the first, second, thirteenth, fourteenth and sixteenth embodiments and the background art section will not be further described below. While data are transmitted through three channels in the DVI standard or the HDMI standard, FIG. 17 shows a single-channel transmission in the DVI standard, as an example, for the sake of simplicity.

Referring to FIG. 17, the transmitter/receiver of the seventeenth embodiment will now be described.

First, the remote controller 23 is used to give the control circuit 141 information on the product manufacturer of the receiver 163. For example, a GUI is used to select one from among a list of product manufacturers. The microcomputer 143 processes the GUI to determine the product manufacturer of the receiver 163 and transmits the information to the data/clock control circuit 142. The data/clock control circuit 142 has a table defining the correspondence between product manufacturers and data- and clock-holding periods, and determines the data- and clock-holding period according to the specified product manufacturer. This can be done by specifying the count value of the counter for each product manufacturer.

For example, where the signal is switched from the SD signal to the HD signal, a signal being the trigger for the switching is output from the microcomputer 143 to the data/clock control circuit 142 at the point of signal transition. The data/clock control circuit 142 initializes the counter at this trigger and counts the specified period of time, thereby outputting to the gate circuits 132 and 133 a signal that is “0” during the specified period of time and “1” during other periods. The gate circuits 132 and 133 output “0” during a period in which the output of the data/clock control circuit 142 is “0”, and thus the output of the data and the clock is stopped for the specified first predetermined period of time. Specifically, it can be stopped for a period of 100 msec for Product Manufacturer A and for a period of 200 msec for Product Manufacturer B.

As the data and the clock are stopped for the first predetermined period of time, the clock recovery circuit 161 detects this and outputs a signal to the reconfiguration circuit 162 indicating that the data or the clock is stopped. If it detects that the data and the clock are both stopped, it is possible to prevent an erroneous detection by the clock recovery circuit 161 due to noise. The reconfiguration circuit 162 counts the data- or clock-holding state, and resets at least one of the receiver 163 and the TV 114 if the data or the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 144 can reliably notify the receiver 163 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 163 of the point of signal transition, thereby reliably initializing the receiver 163 at this point of transition.

Therefore, in the present embodiment, the period for which the data and the clock are stopped is optimized for the receiver 163 and the TV 114, for each product manufacturer. Thus, a signal switching that entails a change in the clock frequency such as from the SD signal to the HD signal or from the HD signal to the SD signal within a short period of time while preventing noise from being displayed on the TV 114.

### Eighteenth Embodiment

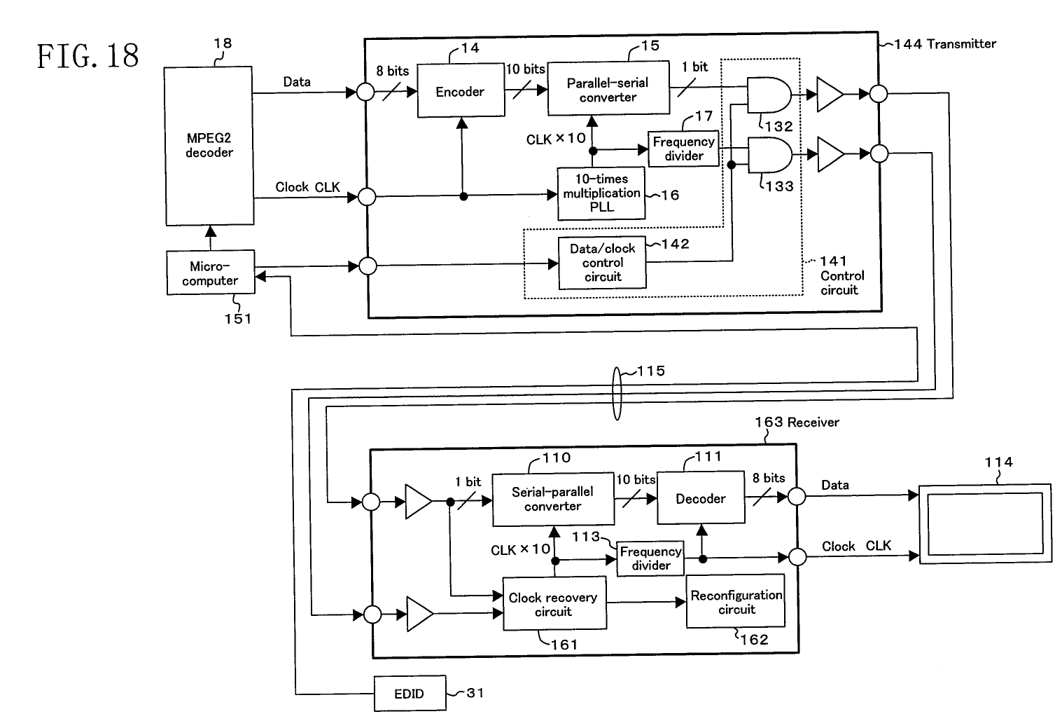

FIG. 18 is a block diagram showing a general configuration of a transmitter/receiver according to an eighteenth embodiment of the present invention.

In the figure, the transmitter 144 and the receiver 163 together form a transmitter/receiver. Elements of the same function as those shown in FIGS. 1, 3, 13 to 16 and those described above in the background art section are denoted by like reference numerals. These elements described above in the first, third and thirteenth to sixteenth embodiments and the background art section will not be further described below. While data are transmitted through three channels in the DVI standard or the HDMI standard, FIG. 18 shows a single-channel transmission in the DVI standard, as an example, for the sake of simplicity.

Referring to FIG. 18, the transmitter/receiver of the eighteenth embodiment will now be described.

The EDID 31 stores various information on the receiver 163 (the receiver means and the reconfiguration means) and the TV 114. For example, it stores the resolutions with which the TV 114 can produce a display, the audio sample rates with which sound can be output, the product manufacturer, the product number, etc. The EDID 31 is stored in the information storing means (not shown) provided in the receiver 43. The microcomputer 151 is provided with a read-out circuit (the read-out means) for accessing the EDID 31 via the cable 115 to obtain various information. The product manufacturer is extracted from among the obtained information, and is set in the data/clock control circuit 142. The data/clock control circuit 142 has a table defining the correspondence between product manufacturers and data- and clock-holding periods, and determines the data- and clock-holding period according to the specified product manufacturer. This can be done by specifying the count value of the counter for each product manufacturer.

For example, where the signal is switched from the SD signal to the HD signal, a signal being the trigger for the switching is output from the microcomputer 151 to the data/clock control circuit 142 at the point of signal transition. The data/clock control circuit 142 initializes the counter at this trigger and counts the specified period of time, thereby outputting to the gate circuits 132 and 133 a signal that is “0” during the specified period of time and “1” during other periods. The gate circuits 132 and 133 output “0” during a period in which the output of the data/clock control circuit 142 is “0”, and thus the output of the data and the clock is stopped for the specified first predetermined period of time. Specifically, it can be stopped for a period of 100 msec for Product Manufacturer A and for a period of 200 msec for Product Manufacturer B.

As the data and the clock are stopped for the first predetermined period of time, the clock recovery circuit 161 detects this and outputs a signal to the reconfiguration circuit 162 indicating that the data or the clock is stopped. If it detects that the data and the clock are both stopped, it is possible to prevent an erroneous detection by the clock recovery circuit 161 due to noise. The reconfiguration circuit 162 counts the data- or clock-holding state, and resets at least one of the receiver 163 and the TV 114 if the data or the clock has been stopped for a second predetermined period of time. This reset operation turns OFF the display on the TV 114 by, for example, turning it to black screen, thus preventing unpleasant noise from being displayed at the point of transition from the SD signal to the HD signal.

By setting the first predetermined period of time to be longer than the second predetermined period of time, the transmitter 144 can reliably notify the receiver 163 of the point of signal transition. The second predetermined period of time can be set to be long enough so that a malfunction will not occur even if noise is introduced along the cable 115, e.g., 50 msec for Product Manufacturer A and 100 msec for Product Manufacturer B. The first predetermined period of time is a period that is sufficiently longer than the second predetermined period of time and is specified for each manufacturer. Thus, it is possible to reliably notify the receiver 163 of the point of signal transition, thereby reliably initializing the receiver 163 at this point of transition.

Therefore, in the present embodiment, the microcomputer 151 reads out information of the EDID 31 to automatically optimize the period for which the data and the clock are stopped for the receiver 163 and the TV 114. Thus, a signal switching that entails a change in the clock frequency such as from the SD signal to the HD signal or from the HD signal to the SD signal can be done within a short period of time while preventing noise from being displayed on the TV 114.

While the above description is directed to a case where the data and the clock are stopped by holding the output of the data and the clock at “0” for the predetermined period of time, the data and the clock may be stopped by holding the output of the data and the clock at “1” for the predetermined period of time. Similar effects can be obtained also when it is held at a high impedance for the predetermined period of time since it will then be fixed to “0” or “1” by the terminator.

If the first predetermined period of time and the second predetermined period of time are shortened to such a degree that a malfunction will not occur even if noise is introduced along the cable 115, a signal switching that entails a change in the frequency can be done quickly while suppressing the display of noise on the TV 114. Alternatively, the first predetermined period of time and the second predetermined period of time may be optimized based on the length of the cable 115. For example, this can be done by the user of the transmitter 136 or 144 and the receiver 163 specifying the cable length using a GUI, with the data/clock control circuit 134 or 142 determining the first predetermined period of time and the reconfiguration circuit 162 determining the second predetermined period of time for each specified cable length.

While the above description is directed to a case where the reconfiguration circuit 162 resets the receiver 163 or the TV 114, the reconfiguration circuit 162 may otherwise reconfigure the receiver 163 or the TV 114 so that the signal switching can be done quickly. For example, the time constant of the filter of the clock recovery circuit 161 may be changed while temporarily stopping the output of the decoder 111 so that it is made to response more quickly than normal only during the signal switching operation. Thus, it is possible to shorten the amount of time for which black screen is displayed on the TV 114.

In addition, while the above description is directed to an example of the DVI standard, similar effects can be obtained with the HDMI standard. Moreover, similar effects can be obtained not only with the DVI standard or the HDMI standard, but also with other similar transmitting/receiving schemes.

### INDUSTRIAL APPLICABILITY

As described above, with control means being provided for controlling the transmission of the clock and the data so as to reduce noise displayed on a TV, or the like, when switching the signal from one to another, the present invention is useful, for example, as a transmitter and a transmitter/receiver of a DVD player or a DVD recorder for transmitting a video signal or an audio signal to a plasma TV or an LCD TV.

1. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the clock from the transmitter means for a predetermined amount of time when switching the frequency of the clock from one to another.

2. The transmitter of claim 1, wherein the transmitter means transmits the data based on a DVI standard or an HDMI standard.

3. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the clock from the transmitter means for a predetermined amount of time when switching the frequency of the clock from one to another,
wherein the control means is given in advance information on the receiver, and specifies the predetermined amount of time for which the transmission of the clock is stopped based on the receiver information.

4. The transmitter of claim 3, wherein the receiver information at least includes information on a manufacturer of the receiver.

5. The transmitter of claim 3, wherein the transmitter means transmits the data based on a DVI standard or an HDMI standard.

6. A transmitter for transmitting a clock and data to a receiver, comprising:
transmitter means for transmitting a clock and data to a receiver via a transmission line, the data being in synchronism with another clock whose frequency is N times that of the clock (where N is a natural number);
control means for stopping the transmission of the clock from the transmitter means for a predetermined amount of time when switching the frequency of the clock from one to another; and
read-out means for reading out information on the receiver from the receiver via the transmission line,
wherein the control means specifies the predetermined amount of time for which the transmission of the clock is stopped based on the receiver information read out by the read-out means.

7. The transmitter of claim 6, wherein the receiver information at least includes information on a manufacturer of the receiver.

8. The transmitter of claim 6, wherein the transmitter means transmits the data based on a DVI standard or an HDMI standard.

9. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the clock from the transmitter means for a first predetermined amount of time when switching the frequency of the clock from one to another; and
the receiver includes:
receiver means connected to the transmitter means via a transmission line; and
reconfiguration means for reconfiguring the receiver means upon detecting that the clock received by the receiver means has stopped for a second predetermined amount of time.

10. The transmitter/receiver of claim 9, wherein the first predetermined amount of time is longer than the second predetermined amount of time.

11. The transmitter/receiver of claim 9, wherein the reconfiguration means provided in the receiver performs the reconfiguration by resetting the receiver means.

12. The transmitter/receiver of claim 9, wherein the transmitter means provided in the transmitter transmits the data based on a DVI standard or an HDMI standard.

13. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the clock from the transmitter means for a first predetermined amount of time when switching the frequency of the clock from one to another;
the receiver includes:
receiver means connected to the transmitter means via a transmission line; and
reconfiguration means for reconfiguring the receiver means upon detecting that the clock received by the receiver means has stopped for a second predetermined amount of time; and
the control means provided in the transmitter is given in advance information on the receiver means provided in the receiver, and specifies the first predetermined amount of time for which the transmission of the clock is stopped based on the receiver means information.

14. The transmitter/receiver of claim 13, wherein the first predetermined amount of time is longer than the second predetermined amount of time.

15. The transmitter/receiver of claim 13, wherein the reconfiguration means provided in the receiver performs the reconfiguration by resetting the receiver means.

16. The transmitter/receiver of claim 13, wherein the transmitter means provided in the transmitter transmits the data based on a DVI standard or an HDMI standard.

17. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number);
control means for stopping the transmission of the clock from the transmitter means for a first predetermined amount of time when switching the frequency of the clock from one to another; and
read-out means for reading out information on the receiver;
the receiver includes:
receiver means connected to the transmitter means via a transmission line;
reconfiguration means for reconfiguring the receiver means upon detecting that the clock received by the receiver means has stopped for a second predetermined amount of time; and
information storing means for storing information on the receiver means or the reconfiguration means;
the read-out means provided in the transmitter reads out the information stored in the information storing means; and
the control means provided in the transmitter specifies the first predetermined amount of time for which the transmission of the clock is stopped based on the information stored in the information storing means and read out by the read-out means.

18. The transmitter/receiver of claim 17, wherein the information stored in the information storing means provided in the receiver at least includes information on a manufacturer of the receiver means or the reconfiguration means.

19. The transmitter/receiver of claim 17, wherein the first predetermined amount of time is longer than the second predetermined amount of time.

20. The transmitter/receiver of claim 17, wherein the reconfiguration means provided in the receiver performs the reconfiguration by resetting the receiver means.

21. The transmitter/receiver of claim 17, wherein the transmitter means provided in the transmitter transmits the data based on a DVI standard or an HDMI standard.

22. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the data from the transmitter means for a predetermined amount of time when switching the frequency of the clock from one to another.

23. The transmitter of cl aim 22, wherein the transmitter means transmits the data based on a DVI standard or an HDMI standard.

24. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the data from the transmitter means for a predetermined amount of time when switching the frequency of the clock from one to another,
wherein the control means is given in advance information on the receiver, and specifies the predetermined amount of time for which the transmission of the data is stopped based on the receiver information.

25. The transmitter of cl aim 24, wherein the receiver information at least includes information on a manufacturer of the receiver.

26. The transmitter of claim 24, wherein the transmitter means transmits the data based on a DVI standard or an HDMI standard.

27. A transmitter for transmitting a clock and data to a receiver, comprising:
transmitter means for transmitting a clock and data to a receiver via a transmission line, the data being in synchronism with another clock whose frequency is N times that of the clock (where N is a natural number);
control means for stopping the transmission of the data from the transmitter means for a predetermined amount of time when switching the frequency of the clock from one to another; and
read-out means for reading out information on the receiver from the receiver via the transmission line,
wherein the control means specifies the predetermined amount of time for which the transmission of the data is stopped based on the receiver information read out by the read-out means.

28. The transmitter of claim 27, wherein the receiver information at least includes information on a manufacturer of the receiver.

29. The transmitter of claim 27, wherein the transmitter means transmits the data based on a DVI standard or an HDMI standard.

30. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the data from the transmitter means for a first predetermined amount of time when switching the frequency of the clock from one to another; and
the receiver includes:
receiver means connected to the transmitter means via a transmission line; and
reconfiguration means for reconfiguring the receiver means upon detecting that the data received by the receiver means has stopped for a second predetermined amount of time.

31. The transmitter/receiver of claim 30, wherein the first predetermined amount of time is longer than the second predetermined amount of time.

32. The transmitter/receiver of claim 30, wherein the reconfiguration means provided in the receiver performs the reconfiguration by resetting the receiver means.

33. The transmitter/receiver of claim 30, wherein the transmitter means provided in the transmitter transmits the data based on a DVI standard or an HDMI standard.

34. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the data from the transmitter means for a first predetermined amount of time when switching the frequency of the clock from one to another;
the receiver includes:
receiver means connected to the transmitter means via a transmission line; and
reconfiguration means for reconfiguring the receiver means upon detecting that the data received by the receiver means has stopped for a second predetermined amount of time; and
the control means provided in the transmitter is given in advance information on the receiver means provided in the receiver, and specifies the first predetermined amount of time for which the transmission of the data is stopped based on the receiver means information.

35. The transmitter/receiver of claim 34, wherein the first predetermined amount of time is longer than the second predetermined amount of time.

36. The transmitter/receiver of claim 34, wherein the reconfiguration means provided in the receiver performs the reconfiguration by resetting the receiver means.

37. The transmitter/receiver of claim 34, wherein the transmitter means provided in the transmitter transmits the data based on a DVI standard or an HDMI standard.

38. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number);
control means for stopping the transmission of the data from the transmitter means for a first predetermined amount of time when switching the frequency of the clock from one to another; and
read-out means for reading out information on the receiver;
the receiver includes:
receiver means connected to the transmitter means via a transmission line;
reconfiguration means for reconfiguring the receiver means upon detecting that the data received by the receiver means has stopped for a second predetermined amount of time; and
information storing means for storing information on the receiver means or the reconfiguration means;
the read-out means provided in the transmitter reads out the information stored in the information storing means; and
the control means provided in the transmitter specifies the first predetermined amount of time for which the transmission of the data is stopped based on the information stored in the information storing means and read out by the read-out means.

39. The transmitter/receiver of claim 38, wherein the information stored in the information storing means provided in the receiver at least includes information on a manufacturer of the receiver means or the reconfiguration means.

40. The transmitter/receiver of claim 38, wherein the first predetermined amount of time is longer than the second predetermined amount of time.

41. The transmitter/receiver of claim 38, wherein the reconfiguration means provided in the receiver performs the reconfiguration by resetting the receiver means.

42. The transmitter/receiver of claim 38, wherein the transmitter means provided in the transmitter transmits the data based on a DVI standard or an HDMI standard.

43. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the clock and the data from the transmitter means for a predetermined amount of time when switching the frequency of the clock from one to another.

44. The transmitter of claim 43, wherein the transmitter means transmits the data based on a DVI standard or an HDMI standard.

45. A transmitter for transmitting a clock and data to a receiver, comprising:
transmitter means for transmitting a clock and data, the data being in synchronism with another clock whose frequency is N times that of the clock (where N is a natural number); and
control means for stopping the transmission of the clock and the data from the transmitter means for a predetermined amount of time when switching the frequency of the clock from one to another,
wherein the control means is given in advance information on the receiver, and specifies the predetermined amount of time for which the transmission of the clock and the data is stopped based on the receiver information.

46. The transmitter of claim 45, wherein the receiver information at least includes information on a manufacturer of the receiver.

47. The transmitter of claim 45, wherein the transmitter means transmits the data based on a DVI standard or an HDMI standard.

48. A transmitter for transmitting a clock and data to a receiver, comprising:
transmitter means for transmitting a clock and data to a receiver via a transmission line, the data being in synchronism with another clock whose frequency is N times that of the clock (where N is a natural number);
control means for stopping the transmission of the clock and the data from the transmitter means for a predetermined amount of time when switching the frequency of the clock from one to another; and
read-out means for reading out information on the receiver from the receiver via the transmission line,
wherein the control means specifies the predetermined amount of time for which the transmission of the clock and the data is stopped based on the receiver information read out by the read-out means.

49. The transmitter of claim 48, wherein the receiver information at least includes information on a manufacturer of the receiver.

50. The transmitter of claim 48, wherein the transmitter means transmits the data based on a DVI standard or an HDMI standard.

51. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the clock and the data from the transmitter means for a first predetermined amount of time when switching the frequency of the clock from one to another; and
the receiver includes:
receiver means connected to the transmitter means via a transmission line; and
reconfiguration means for reconfiguring the receiver means upon detecting that the clock or the data received by the receiver means has stopped for a second predetermined amount of time.

52. The transmitter/receiver of claim 51, wherein the first predetermined amount of time is longer than the second predetermined amount of time.

53. The transmitter/receiver of claim 51, wherein the reconfiguration means provided in the receiver performs the reconfiguration by resetting the receiver means.

54. The transmitter/receiver of claim 51, wherein the transmitter means provided in the transmitter transmits the data based on a DVI standard or an HDMI standard.

55. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number); and
control means for stopping the transmission of the clock and the data from the transmitter means for a first predetermined amount of time when switching the frequency of the clock from one to another;
the receiver includes:
receiver means connected to the transmitter means via a transmission line; and
reconfiguration means for reconfiguring the receiver means upon detecting that the clock or the data received by the receiver means has stopped for a second predetermined amount of time; and
the control means provided in the transmitter is given in advance information on the receiver means provided in the receiver, and specifies the first predetermined amount of time for which the transmission of the data is stopped based on the receiver means information.

56. The transmitter/receiver of claim 55, wherein the first predetermined amount of time is longer than the second predetermined amount of time.

57. The transmitter/receiver of claim 55, wherein the reconfiguration means provided in the receiver performs the reconfiguration by resetting the receiver means.

58. The transmitter/receiver of claim 55, wherein the transmitter means provided in the transmitter transmits the data based on a DVI standard or an HDMI standard.

59. A transmitter/receiver, comprising:
a transmitter for transmitting a clock and data; and
a receiver for receiving the clock and the data transmitted from the transmitter, wherein:
the transmitter includes:
transmitter means for transmitting a clock and data, the data being in synchronism with another clock whose frequency is N times that of the clock (where N is a natural number);
control means for stopping the transmission of the clock and the data from the transmitter means for a first predetermined amount of time when switching the frequency of the clock from one to another; and
read-out means for reading out information on the receiver;
the receiver includes:
receiver means connected to the transmitter means via a transmission line;
reconfiguration means for reconfiguring the receiver means upon detecting that the clock or the data received by the receiver means has stopped for a second predetermined amount of time; and
information storing means for storing information on the receiver means or the reconfiguration means;
the read-out means provided in the transmitter reads out the information stored in the information storing means; and
the control means provided in the transmitter specifies the first predetermined amount of time for which the transmission of the clock and the data is stopped based on the information stored in the information storing means and read out by the read-out means.

60. The transmitter/receiver of claim 59, wherein the information stored in the information storing means provided in the receiver at least includes information on a manufacturer of the receiver means or the reconfiguration means.

61. The transmitter/receiver of claim 59, wherein the first predetermined amount of time is longer than the second predetermined amount of time.

62. The transmitter/receiver of claim 59, wherein the reconfiguration means provided in the receiver performs the reconfiguration by resetting the receiver means.

63. The transmitter/receiver of claim 59, wherein the transmitter means provided in the transmitter transmits the data based on a DVI standard or an HDMI standard.
